(19) United States
(12) Patent Application Publication
(10) Pub. No.: US 2024/0284314 A1
(43) Pub. Date: Aug. 22, 2024

(54) METHOD AND APPARATUS FOR IDENTIFYING ARTIFICIAL INTELLIGENCE AND MACHINE LEARNING FUNCTIONALITIES AND MODELS BETWEEN NODES IN MOBILE COMMUNICATION SYSTEMS

(71) Applicant: Electronics and Telecommunications Research Institute, Daejeon (KR)

(72) Inventors: Han Jun PARK, Daejeon (KR); Yong Jin Kwon, Daejeon (KR); An Seok Lee, Daejeon (KR); Heesoo Lee, Daejeon (KR); Yun Joo Kim, Daejeon (KR); Hyun Seo Park, Daejeon (KR); Jung Bo Son, Daejeon (KR); Yu Ro Lee, Daejeon (KR)

(73) Assignee: Electronics and Telecommunications Research Institute, Daejeon (KR)

(21) Appl. No.: 18/441,667

(22) Filed: Feb. 14, 2024

(30) Foreign Application Priority Data
Feb. 16, 2023 (KR) 10-2023-0020979
Feb. 22, 2023 (KR) 10-2023-0023955
May 15, 2023 (KR) 10-2023-0062475
May 30, 2023 (KR) 10-2023-0069210

(51) Int. Cl. H04W 48/16; H04W 8/22; H04W 64/00; H04W 76/20

(52) U.S. Cl. CPC H04W 48/16; H04W 8/22; H04W 64/00; H04W 76/20

(57) ABSTRACT

A method of identifying AI/ML functionalities/models supported for mobile communication operated in mobile communication systems including a base station and one or more terminals may comprise: identifying, by at least one of the base station or the one or more terminals, information related to the AI/ML functionalities supportable by the one or more terminals; and identifying, by at least one of the base station or the one or more terminals, AI/ML model information supportable by the one or more terminals.

### CROSS-REFERENCE TO RELATED APPLICATIONS

This application claims priority to Korean Patent Applications No. 10-2023-0020979, filed on Feb. 16, 2023, No. 10-2023-0023955, filed on Feb. 22, 2023, No. 10-2023-0062475, filed on May 15, 2023, and No. 10-2023-0069210, filed on May 30, 2023, with the Korean Intellectual Property Office (KIPO), the entire contents of which are hereby incorporated by reference.

### BACKGROUND

### 1. Technical Field

Example embodiments of the present disclosure relates to a method and apparatus for identifying and managing artificial intelligence/machine learning (hereinafter, AI/ML)-based functionalities/models between network nodes such as a base station and/or user equipment (UE) when supporting functionalities/models using the AI/ML in the network nodes, in mobile communication systems that include the base station and one or more UEs.

### 2. Related Art

Contents described in this section simply provide background information for the present embodiment and do not constitute the related art.

Recently, artificial intelligence (AI) and machine learning (ML) technologies have been achieving brilliant results in image and natural language fields. Thanks to the technological advancement of A/ML, researches in academia and industry are actively underway in mobile communication fields that can be applied to the AI/ML technologies in mobile communication systems. For example, in the industry, 3^{rd} Generation Partnership Project (3GPP), which is an international standardization organization, is conducting a study to apply the AI/ML technology to an air interface of mobile communication systems targeting a 5G new radio (5G NR) system.

### SUMMARY

Example embodiments of the present disclosure provide a method of identifying artificial intelligence/machine learning (AI/ML) functionalities/models that can identify AI/ML functionalities, and network configuration information supported for each AI/ML functionality and model information supported for each AI/ML functionality-related network configuration when a base station and/or user equipments (UEs) may support one or more AI/ML functionalities/models for mobile communication in mobile communication systems that include the base station and one or more UEs, and a method and apparatus for managing AI/ML functionalities/models based on the method.

In the related art for applying the AI/ML functionalities/models to the mobile communication systems, the AI/ML functionalities/models have been treated the same as the conventional functionalities/models of the related art rather than the AI/ML functionalities/models, but there is a problem in that the AI/ML functionalities/models are not sufficiently taken into account that the AI/ML functionalities/models are entirely influenced by the given training data.

Example embodiments of the present disclosure provide a two-stage identification method that includes a process of identifying AI/ML functionalities and a process of identifying AI/ML models corresponding to the AI/ML functionalities so that the AI/ML models trained with training data suitable for specific channel environments may be applied even when the AI/ML models have the same network configuration.

Example embodiments of the present disclosure provide a method of managing AI/ML functionalities/models based on a two-stage identification process.

According to a first exemplary embodiment of the present disclosure, a method of identifying artificial intelligence (AI)/machine learning (ML) functionalities/models supported for mobile communication operated in mobile communication systems including a base station and one or more user equipments (UEs) may comprise: identifying, by at least one of the base station or the one or more UEs, information related to the AI/ML functionalities supportable by the one or more UEs; and identifying, by at least one of the base station or the one or more UEs, AI/ML model information supportable by the one or more UEs.

In the identifying of the information related to the AI/ML functionalities supportable by the one or more UEs, the information related to the AI/ML functionalities supportable by the one or more UEs and network configuration information supported for each AI/ML functionality supportable by the one or more UEs may be identified together.

In the identifying of the AI/ML model information supportable by the one or more UEs, AI/ML model information supported for each AI/ML functionality-related network configuration (radio resource control (RRC) (Re)configuration) may be identified.

The identifying of the information related to the AI/ML functionalities supportable by the one or more UEs may include: requesting, by the base station, a UE capability enquiry to the UE; and reporting, by the UE, UE capability information to the base station in response to the UE capability enquiry.

In the reporting of, by the UE, the UE capability information to the base station in response to the UE capability enquiry, the UE capability information including the AI/ML functionalities and the network configuration information supported for each AI/ML functionality may be forwarded to the base station.

In the reporting of, by the UE, the UE capability information to the base station in response to the UE capability enquiry, the UE capability information including at least one of whether network configuration information supported for each AI/ML functionality may be shared for a plurality of AI/ML functionalities or whether the network configuration information may be specialized for individual AI/ML functionalities is forwarded to the base station.

In the reporting of, by the UE, the UE capability information to the base station in response to the UE capability enquiry, general UE capability information and AI/ML functionality-related UE capability information may be reported individually or in an integrated process based on a result of decision on whether to report the general UE capability information and the AI/ML functionality-related UE capability information in respective processes or not.

The identifying of the AI/ML model information supportable by the one or more UEs may include: forwarding, by the base station, AI/ML-related network configuration (RRC (Re)configuration) to the UE; and reporting, by the UE, at least one of one or more model information or model identifier (model ID) information supportable by the UE to the base station.

The AI/ML-related network configuration (RRC (Re)configuration) may include a functionality identifier (functionality ID).

In the reporting of, by the UE, the at least one of the one or more model information or the model ID information supportable by the UE to the base station, the UE may report at least one of model ID information or model information supported for each AI/ML functionality-related network configuration, along with functionality ID information supported for each AI/ML functionality-related network configuration.

The identifying of the AI/ML model information supportable by the one or more UE may further include, after the forwarding of, by the base station, the AI/ML-related network configuration (RRC (Re)configuration) to the UE, forwarding, to the UE, a trigger requesting the one or more model information and the model ID information supportable by the UE.

After the trigger is transmitted, a timer may be set until the UE reports at least one of the one or more model information or the model ID information supportable by the UE in response to the trigger, and when the UE does not report at least one of the one or more model information or the model ID information supportable by the UE until the timer expires, it may be determined that the UE does not respond to valid model information.

In the identifying of the information related to the AI/ML functionalities supportable by the one or more UEs, the base station may forward at least one of operation scenario or operation zone information along with network configuration information supported for each AI/ML functionality to the UE, and in the identifying of the AI/ML model information supportable by the one or more UEs, the UE may report the at least one of the model ID information or the model information supportable by the UE based on at least one of the operation scenario or the operation zone information.

The operation scenario may be one of indoor or outdoor scenarios, and at least one of the operation scenario or the operation zone information may be related to AI/ML-based positioning.

According to a second exemplary embodiment of the present disclosure, in a mobile communication system including a base station and one or more user equipments (UEs), application conditions for artificial intelligence (AI)/machine learning (ML) functionalities to be applied in at least one of the base station or the one or more UEs may be classified into a first application condition independent of a scenario, an area, and a dataset, and a second application condition that depends on at least one of the scenario, the area, or the dataset; and the base station may set the AI/ML functionalities based on the first application condition which is identified by the one or more UEs and is supportable by the one or more UEs, and the second application condition supportable by the one or more UEs for each of the set AI/ML functionalities may be identified for the each of the set AI/ML functionalities.

At least one of the base station or the one or more UEs may identify information related to the AI/ML functionalities supportable by the one or more UEs, and identify AI/ML model information supportable by the one or more UEs, the base station may request a UE capability enquiry to the UE, the UE may report UE capability information to the base station in response to the UE capability enquiry, the base station may forward AI/ML-related network configuration (RRC (Re)configuration) to the UE, and the UE may report at least one of one or more model information or model identifier (model ID) information supportable by the UE to the base station.

According to a third exemplary embodiment of the present disclosure, a method of managing artificial intelligence (AI)/machine learning (ML) functionalities/models supported for mobile communication operated in mobile communication systems including a base station and one or more user equipments (UEs) may comprise: forwarding, by the base station, functionality identifier (functionality ID) information for identifying AI/ML functionality-related network configurations (RRC (Re)configuration) to the UE; forwarding, by the UE, one or more model ID information for identifying supported models for each AI/ML functionality-related network configuration to the base station; and operating, by the base station, at least a part (a part or all) a life cycle management (LCM) process for specific AI/ML functionalities/models using the functionality ID information and the model ID information.

The LCM process may include at least one of data collection, model training, model inference operation, model deployment, model activation, model deactivation, model selection, model monitoring, or model transfer.

The operating of the part or all of the LCM process includes transmitting, by the base station, activation/deactivation information on at least one of specific AI/ML functionalities/models to the UE, when the base station and the UE follow one-way activation/deactivation conditions, the base station may instruct activation/deactivation of at least one of the specific AI/ML functionalities/models based on the activation/deactivation information, and when the base station and the UE follow a two-way activation/deactivation condition, the base station may request the activation/deactivation of at least one of the specific AI/ML functionalities/models based on the activation/deactivation information, and the UE may affirm or deny the activation/deactivation request.

The operating of the part or all of the LCM process may include: forwarding, by the base station, the activation/deactivation information on at least one of the specific AI/ML functionalities/models to the UE; and controlling at least one of the specific AI/ML functionalities/models of the UE to be activated/deactivated based on one or more timers for activating/deactivating at least one of the specific AI/ML functionalities/models configured by the base station.

According to an embodiment of the present disclosure, when a base station and/or UE can support one or more AI/ML functionalities/models for mobile communication, by proposing a two-stage AI/ML functionality/model identification method including the AI/ML functionality ID operation (first operation) of identifying the AI/ML functionalities and the network configuration information supported for each AI/ML functionality and a model ID operation (second operation) of identifying the supported model information (within the AI/ML functionality-related network configuration), it is possible to identify both the AI/ML functionalities and AI/ML models.

According to an embodiment of the present disclosure, it is possible to identify valid model information according to an operation scenario and/or operation zone in an AI/ML model identification operation as well as identify network configurations for AI/ML functionalities in the AI/ML functionality identification operation. Therefore, according to an embodiment of the present disclosure, AI/ML functionalities/models that operate based on data can be identified based on both the perspective of the network configuration and the perspective of the operation scenario/environment.

According to an embodiment of the present disclosure, in a mobile communication system including a base station and one or more UEs, when a base station and/or UE can support one or more AI/ML functionalities for mobile communication, the base station can transmit functionality identifier information for identifying AI/ML functionality-related network configurations to the UE, the UE can transmit one or more model ID information for identifying supported models (for each AI/ML functionality-related network configuration) to the base, and the base station (or network) can operate part or all of an LCM process on a specific AI/ML functionalities/models using a functionality identifier and a model ID.

According to an embodiment of the present disclosure, identifier information for identifying AI/ML functionalities/models can be classified into a functionality identifier for identifying AI/ML functionality-related network configurations and a model ID for identifying supported models (within the AI/ML functionality-related network configurations). Accordingly, it is possible to support more structured and clear management when performing LCM on a specific AI/ML functionality and AI/ML model.

### BRIEF DESCRIPTION OF DRAWINGS

FIG. 1 is a conceptual diagram illustrating a two-stage AI/ML functionality/model identification process according to an embodiment of the present disclosure.

FIG. 2 is a conceptual diagram illustrating the operation scenario/area information when identifying the AI/ML models according to an embodiment of the present disclosure.

FIG. 3 is a conceptual diagram illustrating the process of identifying the AI/ML functionality/model that include the process of transmitting the operation scenario/area information of FIG. 2.

FIG. 4 is a conceptual diagram illustrating the AI/ML functionalities and a process of reporting the network configuration information supported for each AI/ML functionality according to an embodiment of the present disclosure.

FIG. 5 is a conceptual diagram illustrating an AI/ML model information report trigger process according to an embodiment of the present disclosure.

FIG. 6 is a conceptual diagram illustrating a functionality/model activation/deactivation process based on the functionality ID and the model ID according to the embodiment of the present disclosure.

FIG. 7 is a conceptual diagram illustrating a one-way AI/ML functionality/model activation/deactivation process according to an embodiment of the present disclosure.

FIG. 8 is a conceptual diagram illustrating a two-way AI/ML functionality/model activation/deactivation process according to an embodiment of the present disclosure.

FIG. 9 is a conceptual diagram illustrating a timer-based AI/ML functionality/model activation/deactivation process according to an embodiment of the present disclosure.

FIG. 10 is a conceptual diagram illustrating an AI/ML framework according to an embodiment of the present disclosure.

FIG. 11 is a conceptual diagram illustrating an example of a generalized computing system in which a base station and/or a UE in mobile communication system capable of performing at least part of the processes of FIGS. 1 to 10 are implemented.

### DETAILED DESCRIPTION OF THE EMBODIMENTS

While the present disclosure is capable of various modifications and alternative forms, specific embodiments thereof are shown by way of example in the drawings and will herein be described in detail. It should be understood, however, that there is no intent to limit the present disclosure to the particular forms disclosed, but on the contrary, the present disclosure is to cover all modifications, equivalents, and alternatives falling within the spirit and scope of the present disclosure. Like numbers refer to like elements throughout the description of the figures.

It will be understood that, although the terms first, second, etc. may be used herein to describe various elements, these elements should not be limited by these terms. These terms are only used to distinguish one element from another. For example, a first element could be termed a second element, and, similarly, a second element could be termed a first element, without departing from the scope of the present disclosure. As used herein, the term “and/or” includes any and all combinations of one or more of the associated listed items.

In exemplary embodiments of the present disclosure, “at least one of A and B” may refer to “at least one A or B” or “at least one of one or more combinations of A and B”. In addition, “one or more of A and B” may refer to “one or more of A or B” or “one or more of one or more combinations of A and B”.

It will be understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present. Other words used to describe the relationship between elements should be interpreted in a like fashion (i.e., “between” versus “directly between,” “adjacent” versus “directly adjacent,” etc.).

The terminology used herein is for the purpose of describing particular embodiments only and is not intended to be limiting of the present disclosure. As used herein, the singular forms “a,” “an” and “the” are intended to include the plural forms as well, unless the context clearly indicates otherwise. It will be further understood that the terms “comprises,” “comprising,” “includes” and/or “including,” when used herein, specify the presence of stated features, integers, steps, operations, elements, and/or components, but do not preclude the presence or addition of one or more other features, integers, steps, operations, elements, components, and/or groups thereof.

Unless otherwise defined, all terms (including technical and scientific terms) used herein have the same meaning as commonly understood by one of ordinary skill in the art to which this present disclosure belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

A communication system or a memory system to which embodiments according to the present disclosure are applied will be described. The communication system or memory system to which the embodiments according to the present disclosure are applied is not limited to the content described below, and the embodiments according to the present disclosure can be applied to various communication systems. Here, a communication system may be used in the same sense as a communication network.

Meanwhile, even a technology known before the filing date of the present application may be included as a part of the configuration of the present disclosure when necessary, and will be described herein without obscuring the spirit of the present disclosure. However, in describing the configuration of the present disclosure, the detailed description of a technology known before the filing date of the present application that those of ordinary skill in the art can clearly understand may obscure the spirit of the present disclosure, and thus a detailed description of the related art will be omitted.

For example, as technologies for training specific channel environments using artificial intelligence (AI)/machine learning (ML), training/inferring communication parameters, and the like, technologies known before the application of the present disclosure may be used, and at least some of these known techniques may be applied as elemental techniques necessary for practicing the present disclosure.

However, the purpose of the present disclosure is not to claim rights to these known technologies, and the contents of the known technologies may be included as part of the present disclosure within the scope without departing from the spirit of the present disclosure.

Recently, the AI/ML technologies have been achieving brilliant results in image and natural language fields. Thanks to the technological advancement of AI/ML, a study in academia and industry is actively underway in mobile communications fields to apply the AI/ML technologies to mobile communications systems. For example, in the industry, 3^{rd} Generation Partnership Project (3GPP), which is an international standardization organization, is conducting a study to apply the AI/ML technology to an air interface of mobile communication systems targeting a 5G new radio (5G NR) system. The study considers the following three use cases as representative use cases.
(1) AI/ML-based channel state information (CSI) feedback
(2) AI/ML-based beam management
(3) AI/ML-based positioning

First, the CSI feedback refers to a process where a user equipment (UE) reports the CSI to a network to help with precoding decision, and the like in a multiple input multiple output (MIMO) system, and in the AI/ML-based CSI feedback, CSI compression, a use case that increases a compression rate of the channel state information by applying the AI/ML technology, and CSI prediction, a use case that predicts the CSI at a future point in time by applying the AI/ML technology, are being discussed. Second, the beam management refers to a process of allocating transmission beam and/or reception beam resources when applying an analog beam using a spatial filter, and in the AI/ML-based beam management, the beam prediction, a use case for predicting beams of unobserved resources in the spatial or temporal domain by applying the AI/ML technology, is being discussed. Third, the positioning refers to a technique for measuring a position of UE, and in the AI/ML-based positioning, AI/ML assisted positioning, a use case that improves the accuracy of conventional positioning techniques by applying the AI/ML technology and direct AI/ML positioning, a use case that directly estimates a position of UE by applying the AI/ML technology, are being discussed.

Since the AI/ML technology is based on training data, life cycle management (hereinafter, LCM) for creation, maintenance, and the like of AI/ML models according to a change in training data may should be able to be performed. Therefore, when applying a function (hereinafter referred to as AI/ML function) based on AI/ML technology in a mobile communication system including a base station and/or UE as in the above use cases, the mobile communication system should be able to support the LCM. In this regard, in the 3GPP, as the detailed operations of the LCM process, data collection, model training, model inference operation, model deployment, model activation, model deactivation, model selection, model monitoring, model transfer, and the like are being discussed. For example, in the mobile communication system, specific AI/ML models may be managed through the LCM such as data collection→model training→model deployment→model activation→model inference operation→model monitoring.

Meanwhile, before operating/performing the LCM on AI/ML functionality and model in the mobile communication system, the AI/ML functionality and model(s) supported within the network should first be able to be identified. For example, the base station may instruct the UE to identify which of the AI/ML functionalities/models may be supported and activation, etc., of specific AI/ML functionalities/models at a UE side based on the identified AI/ML functionalities/models. Regarding the identification of the AI/ML functionalities/models, the following two LCM directivities are being discussed:
(1) Model-identifier (model-ID) based LCM
(2) Functionality-based LCM

First, the model-ID-based LCM refers to an LCM process in which the base station (or base station-side server) and the UE (or UE-side server) share AI/ML model information with model-ID in advance, and then the AI/ML models are identified and managed through the model-ID, etc., between the base station and the UE. Second, the functionality-based LCM refers to an LCM process in which the base station (or base station-side server) and the UE (or UE-side server) share functionality information for the AI/ML functionality in advance, and then the base station and the UE identify and manage the AI/ML functionality through a functionality name (or functionality ID), and the like. In the above conventional discussion, the definition and scope of AI/ML functionalities/models are unclear, and it does not suggest a method of identifying specific AI/ML functionalities/models between a base station and UE. For example, there is a limitation in that the model-ID-based LCM method does not support management of functionality units when a plurality of functionalities (or configurations) are implemented as a single model, and the functionality-based LCM method does not support management on a model-by-model basis when a plurality of models for single functionality are implemented.

Hereinafter, for convenience of description, the artificial neural network learning and configuration method proposed in the present disclosure will be mainly described from a downlink perspective of a wireless mobile communication system including a base station and UE. However, the embodiments of the proposed method of the present disclosure may be extended and applied to any wireless mobile communication systems including a transmitter and a receiver. Hereinafter, the network configurations are used as a term encompassing base station configuration and/or UE configuration.

Hereinafter, preferred embodiments of the present disclosure will be described in more detail with reference to the attached drawings. In order to facilitate overall understanding when describing the present disclosure, the same reference numerals are used for the same components in the drawings, and duplicate descriptions for the same components are omitted.

### Method of Identifying AI/ML Functionality/Model

### Embodiment 01 of Proposed Method

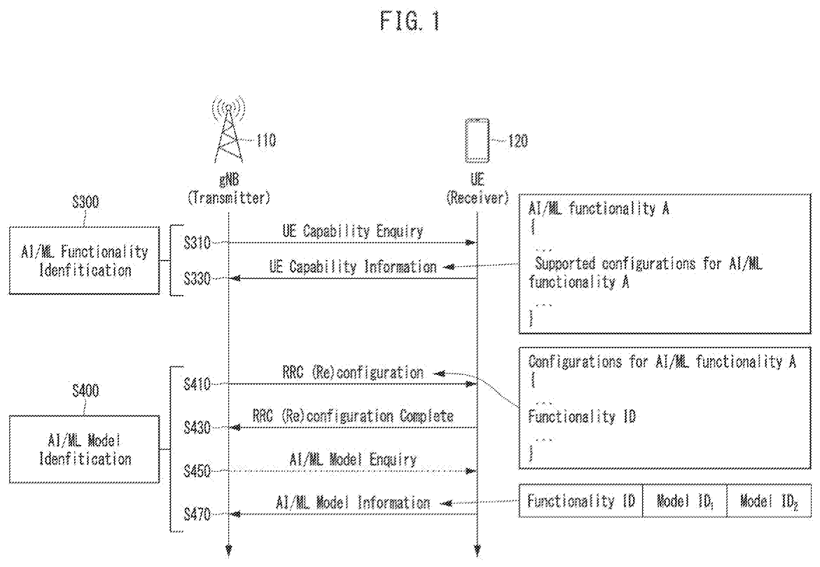

FIG. 1 is a conceptual diagram illustrating a two-stage AI/ML functionality/model identification process according to an embodiment of the present disclosure.

Referring to FIG. 1, the present disclosure provides a two-stage AI/ML functionality and model identification method. In a mobile communication system including a base station 110 and one or more UEs 120, when the base station 110 and/or the UE 120 may support one or more AI/ML functionalities/models for mobile communication, the two-stage AI/ML functionality/model identification method includes an AI/ML functionality identification operation (a first operation S300) of identifying AI/ML functionalities and network configuration information supported for each AI/ML functionality and a model identification operation (a second operation S400) of identifying supported model information (within AI/ML functionality-related network configuration).

### (1) First Operation S300: AI/ML Functionality Identification

A. The base station 110 transmits a UE capability enquiry to the UE 120 (S310).
B. The UE 120 reports UE capability information to the base station 110 (S330).
C. The UE capability information may include the AI/ML functionalities and the network configuration information supported for each AI/ML functionality.

### (2) Second Operation S400: AI/ML Model Identification Operation (Model Identification)

A. The base station 110 transmits AI/ML functionality-related network configurations (e.g., radio resource control (RRC) (Re)configuration) (S410).
B. The AI/ML functionality-related network configurations may include a functionality identifier (functionality ID).
C. The UE 120 may report one or more model information and/or model identifier (model ID) information (supported for each AI/ML functionality-related network configuration) along with the functionality ID information (S470).

Here, when the UE 120 receives the AI/ML functionality-related network configurations and does not report the model ID information and/or the model information, the base station 110 may interpret that there is no model applicable to a current local area for the corresponding network configuration, and it is not locally valid, and the network supported configurations by the UE capability has been applied, so it is not determined as RRC (Re)configuration Failure.

Here, the base station 110 may operate/perform LCM on specific AI/ML models of specific AI/ML functionalities using the functionality ID and the model ID. The LCM may include data collection, model training, model inference operation, model deployment, model activation, model deactivation, model selection, model monitoring, model transfer, and the like.

Here, the first operation S300 and the second operation S400 may be performed continuously. That is, when the UE 120 transmits the UE capability information to the base station 110, the base station 110 may transmit information on the AI/ML functionality-related network configurations to the UE 120 based on receiving the UE capability information. Alternatively, the first operation S300 and the second operation S400 may be performed independently.

According to a modified or expanded embodiment of the present disclosure, in the next-generation mobile communication system, the base station (or network) may identify functionalities supported by the UE and then transmit a UE capability enquiry control signal to the UE for the purpose of determining the network configuration, and the UE may respond to the control signal with a UE capability information report. The UE capability information is information on UE functionalities and represents the functionalities supported by the UE and the network configuration information supported for each functionalities. In the conventional systems, the implementation of the plurality of UEs for single functionality or single network configuration was not considered. However, unlike the existing UE functionalities (other than AI/ML), the AI/ML functionality is functionality based on training data, so it may be necessary to apply a plurality of implementations or a plurality of models to the same network configuration. For example, when two base stations having the same network configuration are experiencing different channel environments, it may be effective to apply AI/ML models trained with training data appropriate for each channel environment.

Therefore, there is a need to divide the AI/ML model in addition to the AI/ML functionalities. Here, the AI/ML model may be used for the purpose of dividing one or more AI/ML implementations within the specific UE functionality. For example, when defining the AI/ML model from the perspective of an object implemented in an actual code, there may be cases where one AI/ML model supports a plurality of network configurations. In this case, it may be difficult to control the AI/ML functionality on a model-by-model basis.

Accordingly, the present disclosure provides the two-stage AI/ML functionality and model identification method. In the mobile communication system including the base station and one or more UEs, when the base station and/or the UE may support one or more AI/ML functionalities/models for mobile communication, the two-stage AI/ML functionality/model identification method includes the AI/ML functionality identification operation (first operation) of identifying the AI/ML functionalities and the network configuration information supported for each AI/ML functionality and the model identification operation (second operation) of identifying the supported model information (within the AI/ML functionality-related network configuration). In the AI/ML functionality identification operation that is the first operation, the base station may transmit the UE capability enquiry to the UE, and the UE may respond to the UE capability information including the AI/ML functionalities and the network configuration information supported for each AI/ML functionality. In the AI/ML model identification operation that is the second operation, the base station may transmit the AI/ML functionality-related network configurations including the functionality ID to the UE, and the UE may report the supported model information or the model ID information (for each AI/ML functionality-related network configuration) along with the functionality ID information.

FIG. 1 exemplarily illustrates the operation according to [Embodiment 01 of Proposed Method]. Referring back to FIG. 1, the base station 110 and the UE 120 first identify the AI/ML functionalities and the supported configurations for each AI/ML functionality through the UE capability enquiry (S310) and UE capability information report (S330) processes (S300). The UE capability enquiry (S310) and UE capability information reporting (S330) processes may be included in the first operation S300 of Embodiment 01 of Proposed Method.

Thereafter, the base station 110 may forward the AI/ML functionality-related network configurations through RRC signaling within the supported configurations by the UE 120 (S410), and in this case, also may forward the AI/ML functionality ID information for identifying the AI/ML functionality-related network configurations together. Thereafter, the UE 120 may report the AI/ML functionality ID and one or more model information and/or model ID information supported for the corresponding AI/ML functionality ID to the base station through a medium access control (MAC) control element (CE) (S470). Thereafter, the base station 110 may operate/perform the LCM on the specific model of the specific functionality using the functionality ID and model ID. The LCM may include data collection, model training, model inference operation, model deployment, model activation, model deactivation, model selection, model monitoring, model transfer, and the like.

The RRC signaling (S410 and S430) for the AI/ML functionality-related network configurations in FIG. 1, AI/ML model enquiry (S450), and signaling for AI/ML model information (S470) may be included in the second operation S400 of Embodiment 01 of Proposed Method.

In the first operation S300 and the second operation S400 illustrated in FIG. 1, the subject of ‘identification’ may be the UE 120 or the base station 110, and it will be obviously understood by those skilled in the art that the identification process may be performed through cooperation between the terminal 120 and the base station 110.

The above [Embodiment 01 of Proposed Method] may be applied along with other embodiment(s) of the proposed method of the present disclosure within the range such that the other embodiment(s) does (do) not conflict with Embodiment 01 of Proposed Method.

### Embodiment 02 of Proposed Method

According to the present disclosure, in a mobile communication system including a base station and one or more UEs, when the base station and/or the UEs may support one or more AI/ML functionalities/models for mobile communication, for example, in the process of identifying supported models for each AI/ML functionality-related network configuration, such as the second operation of [Embodiment 01 of Proposed Method], a method is provided in which the base station transmits the AI/ML functionality-related network configuration, including an operation scenario and/or operation zone information when transmitting the AI/ML functionality-related network configurations to the UEs, and the UEs report the supported model information or model ID information by referring to the operation scenario and/or operation zone information.

Here, the operation scenario and/or operation zone information may be information transmitted from the base station to the UE to dividing training data when the UE collects data for training the AI/ML models.

Here, the operation scenario and/or operation zone information may be reflected and reported in the model information or model ID information.

As an embodiment of the present disclosure, in the next-generation mobile communication system, when the base station and/or UEs may support one or more AI/ML functionalities/models for mobile communication, the AI/ML functionality-related network supported configurations between the base station and the UEs may first be identified and then the AI/ML supported models for each AI/ML functionality-related network configuration may be identified. In this case, the process of determining whether the AI/ML models can be supported may include a process of determining whether the training data applied to the AI/ML models is suitable for the current local. For example, the embodiment is disclosed under the assumption that the AI/ML operation zone is divided into virtual zones 1, 2, through N by the network. Then, there may be the AI/ML models trained only for some of the N zones, and in order for the UE to determine whether the AI/ML models for each zone is available, it is necessary to specify for which of the N zones the base station is requesting the model or model ID information. In general, when the base station intends to identify the supported models for each AI/ML functionality-related network configuration, it may be preferable to transmit both the operation scenario and/or operation zone information to which the AI/ML functionality-related network configurations will be applied. A specific example of the AI/ML functionality that requires the operation scenario/operation zone information may be AI/ML-based positioning. Among the AI/ML-based positioning techniques, the technique that directly infers the UE location using AI/ML may be considered to be an evolved RF fingerprinting technique, and may have characteristics of excellent performance in trained areas, but may have characteristics of greatly deteriorating performance in untrained areas. Therefore, in order to support the AI/ML-based positioning, the base station may provide the operation zone information so that the UE may take action to report appropriate AI/ML models.

Accordingly, according to the present disclosure, in a mobile communication system including a base station and one or more UEs, when the base station and/or the UEs may support one or more AI/ML functionalities/models for mobile communication, for example, in the process of identifying the supported models for each AI/ML functionality-related network configuration, a method is provided in which the base station transmits the AI/ML functionality-related network configuration, including an operation scenario and/or operation zone information when transmitting the AI/ML functionality-related network configurations to the UEs, and the UEs report the supported model information or model ID information by referring to the operation scenario and/or operation zone information.

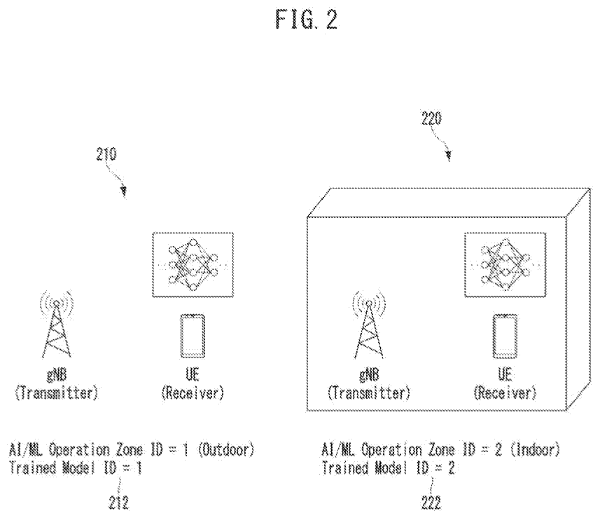

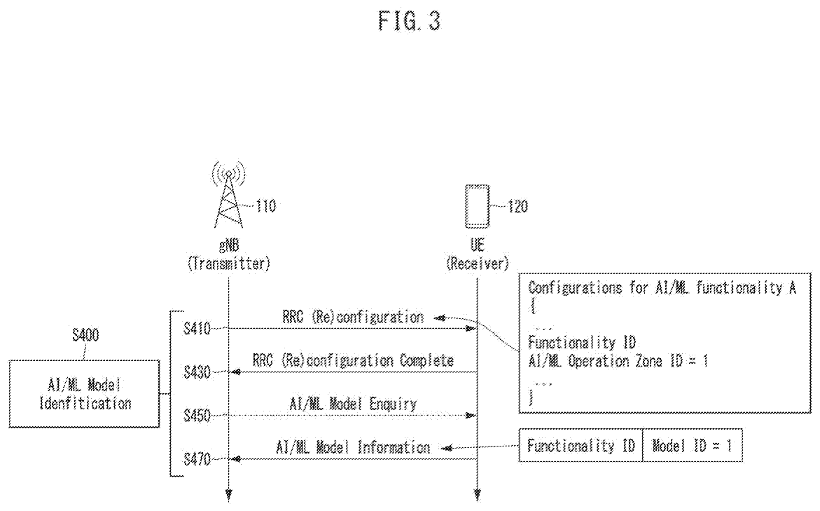

FIGS. 2 and 3 illustrate the operation according to the [Embodiments of Proposed Method]. FIG. 2 is a conceptual diagram illustrating the operation scenario/area information when identifying the AI/ML models according to an embodiment of the present disclosure.

Referring to FIG. 2, operation scenario 1 210 may be a scenario assuming an outdoor situation. In this case, the operation zone information and the AI/ML models ID corresponding to the operation scenario 1 210 may be provided by a data field 212.

Referring to FIG. 3, operation scenario 2 220 may be a scenario assuming an indoor situation. In this case, the operation zone information and the AI/ML models ID corresponding to the operation scenario 2 220 may be provided by a data field 222.

FIG. 3 is a conceptual diagram illustrating the process of identifying the AI/ML functionality/model that include the process of transmitting the operation scenario/area information of FIG. 2.

Referring to FIGS. 2 and 3 together, the base station 110 transmits the AI/ML functionality-related network configurations through the RRC signaling within the supported configurations by the UE 120 (S410), and in this case, transmits the AI/ML functionality ID information for identifying the AI/ML functionality-related network configurations together. In addition, the operation scenario and/or operation zone information targeted by the AI/ML functionality-related network configurations are transmitted together.

In the embodiment of FIGS. 2 and 3, whether the scenario is the outdoor/indoor may be forwarded as the operation scenario information. Thereafter, the UE 120 may report the AI/ML functionality ID and one or more model information and/or model ID information for the corresponding AI/ML functionality ID to the base station through the MAC CE (S470). Here, the model(s) reported by the UE 120 may support the AI/ML functionality-related network configurations configured by the base station 110 and may be interpreted as a valid model for the operation scenario and/or operation zone targeted by the corresponding configuration.

Furthermore, unlike the embodiment of FIG. 2, the operation scenario and/or operation zone information targeted by the AI/ML functionality-related network configurations may be determined based on various standards/rules. That is, in the embodiment of FIGS. 2 and 3, the base station 110 transmits whether the scenario is the outdoor/indoor to the UE 120 as the operation scenario information, but the operation scenario may be determined based on geographic location, functionality, etc.

The above [Embodiment 02 of Proposed Method] may be applied along with other embodiment(s) of the proposed method of the present disclosure within the range that the other embodiment(s) does (do) not conflict with Embodiment 02 of Proposed Method.

### Embodiment 03 of Proposed Method

According to the present disclosure, in a mobile communication system including a base station and one or more UEs, when the base station and/or the UEs may support one or more AI/ML functionalities for mobile communication and when the UEs report the AI/ML functionalities and network configuration information supported for each AI/ML functionality in the form of the UE capability information, a method of reporting the AI/ML functionality-related UE capability information by one of the following methods is provided.
(1) Method 1: Report the existing UE capability information, including the AI/ML functionality-related UE capability information, in the existing UE capability information reporting operation in response to the UE capability enquiry request from the base station (or network).
(2) Method 2: Report the AI/ML functionality-related UE capability information in an additional reporting operation for AI/ML functionalities after the existing UE capability information reporting operation (first operation) in response to the UE capability enquiry request from the base station (or network).

Here, the base station (or network) may instruct the UE whether to include the AI/ML functionality-related UE capability information when requesting the UE capability enquiry, and may follow the method 1 when instructing to include the AI/ML functionality-related UE capability information and follow the method 2 when instructed not to include the AI/ML functionality-related UE capability information.

Here, as an example of the method 1, the UE may report the UE capability information on whether to support the second operation to the base station (or network) in the first operation of Embodiment 01 of Proposed Method. Alternatively, as an example of the method 2, the UE may report the UE capability information on whether to support the second operation to the base station (or network) independent of the first operation of Embodiment 01 of Proposed Method. In this case, the UE may determine whether to report the AI/ML UE capability by including the AI/ML UE capability in general UE capability information based on instructions or information transmitted from the base station or network, or to report the AI/ML UE capability individually using the additional reporting operation (second operation).

Here, when the base station (or network) and/or the UE may configure (or assign) the UE wireless capability identifier for the UE capability information, the base station (or network) and/or the UE may be configured (or assigned) to divide a UE wireless capability identifier for the existing UE capability information and a UE wireless capability identifier for the AI/ML functionality-related UE capability information.

According to an embodiment of the present disclosure, in the next-generation mobile communication system, when the base station and/or UEs may support one or more AI/ML functionalities/models for mobile communication, the AI/ML functionality-related network supported configurations between the base station and the UEs may first be identified and then the AI/ML supported models for each AI/ML functionality-related network configuration may be identified. The process of identifying the AI/ML functionality-related network configurations may be performed by the process of reporting the AI/ML functionalities and the network configuration information supported for each AI/ML functionality in the form of the UE capability information. The AI/ML functionality-related UE capability information may be transmitted along with the existing UE capability information. Alternatively, for the purpose of separately managing the AI/ML functionality-related UE capability information, the AI/ML functionality-related UE capability information may be distinguished from the existing UE capability information and reported to the base station (or network) through a separate report process exclusively for AI. For example, the base station (or network) may transmit a UE AI capability enquiry control signal, and the UE may respond to a UE AI capability information report to the control signal. The UE AI capability enquiry/UE AI capability information report may be a procedure that is distinguished from the existing UE capability enquiry/UE capability information report procedure.

The above [Embodiment 03 of Proposed Method] may be applied along with other embodiment(s) of the proposed method of the present disclosure within the range such that the other embodiment(s) does (do) not conflict with Embodiment 03 of Proposed Method.

### Embodiment 04 of Proposed Method

According to the present disclosure, in a mobile communication system including a base station and one or more UEs, when the base station and/or the UEs may support one or more AI/ML functionalities for mobile communication, a method of defining network configuration (first type configuration)(s) shared for a plurality of AI/ML functionalities and network configuration (second type configuration)(s) specialized for individual AI/ML functionalities when the UEs report the AI/ML functionalities and network configuration information supported for each AI/ML functionality, and dividing, configuring, and reporting the supported configuration information for each AI/ML functionality into the first type configuration(s) and/or second type configuration(s) is provided.

Here, the UE may report the AI/ML functionalities and the network configuration information supported for each AI/ML functionality in the form of the UE capability information. In this case, the transmission and reception of the AI/ML functionalities and the network configuration information supported for each AI/ML functionality may be included in the existing UE capability information report procedure. Alternatively, the transmission and reception of the AI/ML functionalities and the network configuration information supported for each AI/ML functionality may be included in the UE capability information report procedure that is distinguished from the existing UE capability information report procedure. Alternatively, the transmission and reception of the AI/ML functionalities and network configuration information supported for each AI/ML functionality may be included in a UE capability information report procedure that is distinguished from the existing UE capability information report procedure.

Here, when the supported configurations for each AI/ML functionality include first type configuration(s)-related information, the supported configurations may be configured to refer to the first type configuration information through an identifier, including an identifier(s) for the first type configuration(s) without directly including the first type configuration(s).

Here, the first type configuration(s) may be AI/ML functionality operating condition-related configuration.

As an embodiment of the present disclosure, in the next-generation mobile communication system, when the base station and/or UEs may support one or more AI/ML functionalities/models for mobile communication, the AI/ML functionality-related network supported configurations between the base station and the UEs may first be identified and then the AI/ML supported models for each AI/ML functionality-related network configuration may be identified. The process of identifying the AI/ML functionality-related network configurations may be performed by the process of reporting the AI/ML functionalities and the network configuration information supported for each AI/ML functionality in the form of the UE capability information. The AI/ML functionality-related UE capability information may refer to the network configuration information supported for each AI/ML functionality. In this case, the network supported configurations for each AI/ML functionality may include configuration that are conditions for operating the AI/ML functionalities. For example, in the case of the AI/ML functionalities that utilizes channel information in the AI/ML inference process, channel state information reference signal (CSI-RS) resource configuration, etc., may be required as the operating conditions, and the CSI-RS resource configuration may be reported by being included in the network configuration information supported for each AI/ML functionality. However, when the UE reports the network configuration information supported for each AI/ML functionality, in the case where the configuration information that is the operating conditions for each functionality is reported separately, overlapping operating conditions for the AI/ML functionalities may occur, and thus, the signal transmission efficiency may decrease.

Accordingly, according to the present disclosure, in a mobile communication system including a base station and one or more UEs, when the base station and/or the UEs may support one or more AI/ML functionalities for mobile communication, a method of defining network configuration (first type configuration)(s) shared for a plurality of AI/ML functionalities and network configuration (second type configuration)(s) specialized for individual AI/ML functionalities when the base station and/or the UEs report the AI/ML functionalities and network configuration information supported for each AI/ML functionality, and dividing, configuring, and reporting the supported configuration information for each AI/ML functionality into the first type configuration(s) and/or second type configuration(s) is provided.

The above [Embodiment 04 of Proposed Method] may be applied along with other embodiment(s) of the proposed method of the present disclosure within the range that the other embodiment(s) does (do) not conflict with Embodiment 04 of Proposed Method.

### Embodiment 05 of Proposed Method

According to the present disclosure, in a mobile communication system including a base station and one or more UEs, when the base station and/or the UEs may support one or more AI/ML functionalities for mobile communication, a method is provided in which the base station (or network) requests the UEs to report the AI/ML functionalities and supported configurations for each AI/ML functionality when the UEs support AI/ML functionalities and network configuration information supported for each AI/ML functionality, and the UEs request the AI/ML functionalities and the supported configuration information for each AI/ML functionality by one or more of the following methods in response to the base station (or network) request.
(1) When the base station (or network) explicitly instructs the UE on the operating conditions of the AI/ML functionalities:
A. Method 1-1: Report the AI/ML functionalities corresponding to the operating conditions of the instructed AI/ML functionalities and supported configuration information for each AI/ML function.
(2) When the base station (or network) does not explicitly instruct the UE on the operating conditions of the AI/ML functionalities:
A. Method 2-1: Assume the current network configuration as the operating conditions for the AI/ML functionalities and then report the AI/ML functionalities and the supported configuration information for each AI/ML functionality; and
B. Method 2-2: Report the AI/ML functionalities including the operating conditions of the AI/ML functionalities and the supported configuration information for each AI/ML functionality.

Here, the UE may report the AI/ML functionalities and the network configuration information supported for each AI/ML functionality in the form of the UE capability information. In this case, the transmission and reception of the AI/ML functionalities and the network configuration information supported for each AI/ML functionality may be included in the existing UE capability information report procedure. Alternatively, the transmission and reception of the AI/ML functionalities and the network configuration information supported for each AI/ML functionality may be included in the UE capability information report procedure that is distinguished from the existing UE capability information report procedure. Alternatively, the transmission and reception of the AI/ML functionalities and network configuration information supported for each AI/ML functionality may be included in a UE capability information report procedure that is distinct from the existing UE capability information report procedure.

As an embodiment of the present disclosure, in the next-generation mobile communication system, when the base station and/or UEs may support one or more AI/ML functionalities/models for mobile communication, the AI/ML functionality-related network supported configurations between the base station and the UEs may first be identified and then the AI/ML supported models for each AI/ML functionality-related network configuration may be identified. The process of identifying the AI/ML functionality-related network configurations may be performed by the process of reporting the AI/ML functionalities and the network configuration information supported for each AI/ML functionality in the form of the UE capability information. The AI/ML functionality-related UE capability information may mean the network configuration information supported for each AI/ML functionality. In this case, the network supported configurations for each AI/ML functionality may include configuration that are conditions for operating the AI/ML functionalities. For example, in the case of the AI/ML functionalities that utilizes the channel information in the AI/ML inference process, the CSI-RS resource configuration, etc., may be required as the operating conditions, and the CSI-RS resource configuration may be reported by being included in the network configuration information supported for each AI/ML functionality. The conditions for operating the AI/ML functionalities may be reported by the UE to the base station, but the base station may also inform the UE of the operating conditions by considering a candidate group of the network configuration to be operated in a commercial environment. In the latter case, the UE may report the AI/ML functionalities and the supported configuration information for each AI/ML functionality within the operating conditions specified by the base station. When the base station does not specify the operating conditions, the UE may report the AI/ML functionalities for all the operating conditions and the supported configuration information for each AI/ML functionality, but in a simpler operation, the current network configuration are assumed as the operating conditions and the AI/ML functionalities and the supported configuration information for each AI/ML functionality may be reported.

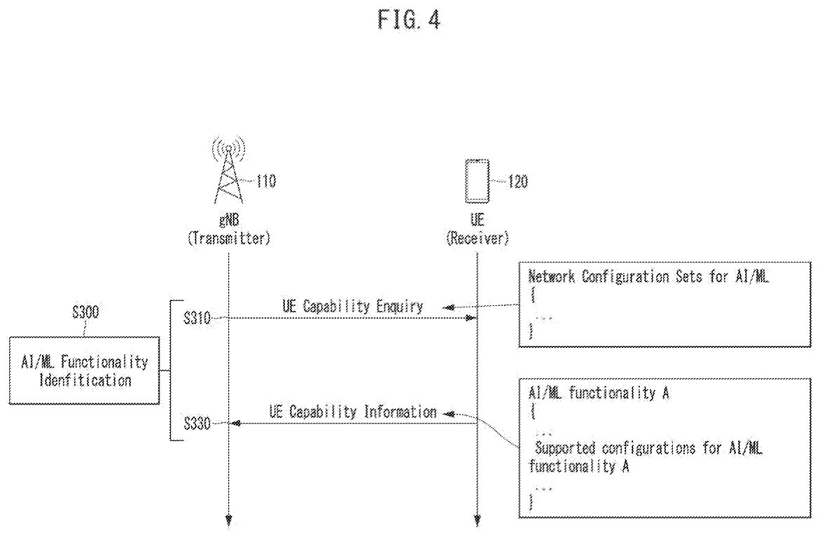

FIG. 4 exemplarily illustrates the operation according to [Embodiment 05 of Proposed Method]. FIG. 4 is a conceptual diagram illustrating the AI/ML functionalities and a process of reporting the network configuration information supported for each AI/ML functionality according to an embodiment of the present disclosure.

Referring to FIG. 4, when the base station 110 transmits the UE capability enquiry (S310), the UE 120 responds to the corresponding enquiry to report the AI/ML functionalities and the network configuration information supported for each AI/ML functionality in the form of the UE capability information (S330). In this case, the base station 110 may transmit the UE capability enquiry, including the operating conditions of the AI/ML functionalities (S310), and the UE 120 may report the AI/ML functionalities corresponding to the operating conditions of the AI/ML functionalities and the supported configuration information for each AI/ML functionality (S330).

When the base station 110 does not specify the operating conditions of the AI/ML functionalities, the UE 120 may report the AI/ML functionalities for all the operating conditions and the supported configuration information for each AI/ML functionality (S330), or when the current network configuration exists, the UE 120 may assume the current network configuration as the operating conditions and then report the AI/ML functionalities and the supported configuration information for each AI/ML functionality may be reported (S330).

Here, the procedure of FIG. 4 may be included in the existing UE capability information report procedure. Alternatively, the procedure of FIG. 4 may be included in the UE capability information report procedure that is distinguished from the existing UE capability information report procedure. For example, the procedure of FIG. 4 may be performed after the existing UE capability information report operation in response to the UE capability enquiry request from the base station (or network).

The above [Embodiment 05 of Proposed Method] may be applied along with other embodiment(s) of the proposed method of the present disclosure within the range such that the other embodiment(s) does (do) not conflict with Embodiment 05 of Proposed Method.

### Method of Managing AI/ML Functionality/Model

### Embodiment 06 of Proposed Method

According to the present disclosure, in a mobile communication system including a base station and one or more UEs, when the base station and/or the UEs may support one or more AI/ML functionalities for mobile communication, a method of reporting, by the UEs, supported model information or model ID information corresponding to the AI/ML functionality-related network configurations by one or more of the following methods when the base station transmits AI/ML functionality-related network configurations to the UEs is provided.
(1) Method 1: Transmit, by the base station, the AI/ML functionality-related network configurations to the UE, and report, by the UE, the supported model information or model ID information in response to the configuration
(2) Method 2: When the base station transmits the AI/ML functionality-related network configurations to the UE and triggers the model information report for the network configuration, report the model information or model ID information that the UE can support in response to the trigger.

Here, in case of the method 1, the base station may operate a timer to wait for a response from the UE, and after the timer expires, the base station may be determined that the UE does not respond (or there is no valid model information).

Here, when the base station transmits the AI/ML functionality-related network configurations to the UE, the base station may transmit the AI/ML functionality-related network configuration, including functionality ID information for identifying the configuration, and then, when the base station triggers the model information report for the AI/ML functionality-related network configuration, the base station may transmit the functionality ID information to the UE to divide the configuration which is the target of the model information report.

According to an embodiment of the present disclosure, in the next-generation mobile communication system, when the base station and/or UE may support one or more AI/ML functionalities/models for mobile communication, the AI/ML functionality-related network supported configurations between the base station and the UE may first be identified and then the AI/ML supported models for each AI/ML functionality-related network configuration may be identified. In the AI/ML model identification operation, the base station may transmit the AI/ML functionality-related network configurations including the functionality ID to the UE, and the UE may report the supported model information or model ID information (for each AI/ML functionality-related network configuration) along with the functionality ID information. The model information or model ID information report of the UE may be performed as an automatic response to the AI/ML functionality-related network configurations of the UE, but the base station may receive the report by instruction by a separate control signal after the AI/ML functionality-related network configuration. Accordingly, according to the present disclosure, in a mobile communication system including a base station and one or more UEs, when the base station and/or the UEs may support one or more AI/ML functionalities for mobile communication, a method is provided in which the UEs report supported model information or model ID information corresponding to the AI/ML functionality-related network configurations by one or more of the methods 1 and 2 of Embodiment 06 of Proposed Method when the base station transmits AI/ML functionality-related network configurations to the UEs.

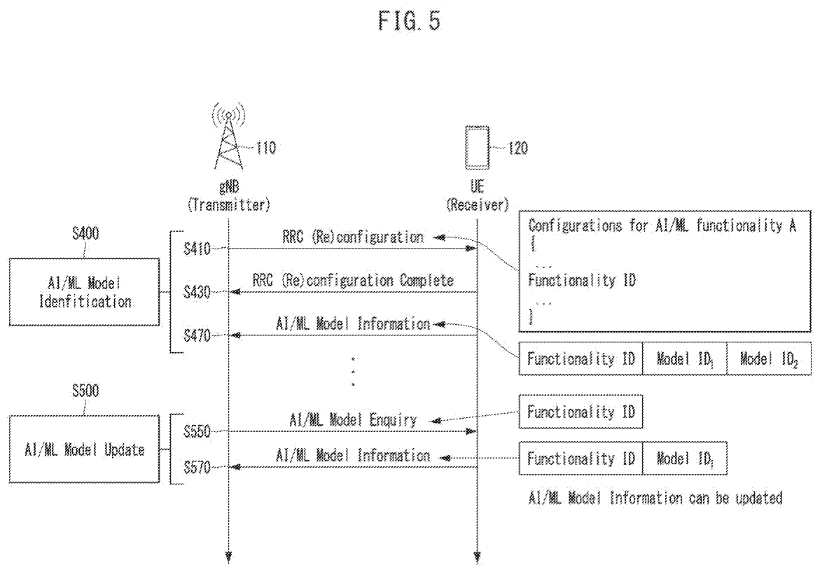

FIG. 5 exemplarily illustrates the operation according to [Embodiment 06 of Proposed Method]. FIG. 5 is a conceptual diagram illustrating an AI/ML model information report trigger process according to an embodiment of the present disclosure.

Referring to FIG. 5, the base station 110 may forward/transmit the AI/ML functionality-related network configurations to the UE 120 through an RRC (Re)configuration process (S410), and in this case, may forward/transmit the functionality ID as information that may classify the corresponding configuration. Thereafter, the UE 120 may set/configure the model information and/or the model ID information supported for the corresponding functionality ID and may report the configured supported model information and/or model ID information to the base station in the form of the MAC CE (Method 1, S430 and S470). Thereafter, when the base station 110 does not receive the model information from the UE 120 or when a long time has passed since receiving the model information, the base station 110 may transmit the MAC CE including the functionality ID to the UE 120 to trigger the model information report for the corresponding functionality ID. When receiving the model information report trigger, the UE 120 may report the model information corresponding to the functionality ID to the base station 110 (Method 2).

The base station 110 may receive the model information after the Method 1 and/or Method 2, and then request the UE 120 to enquire the AI/ML models when a predetermined time has elapsed (S550). In this case, the AI/ML model enquiry may include the functionality ID.

The UE 120 may report the model information corresponding to the functionality ID to the base station 110 using the model ID in response to the AI/ML model enquiry (S570). In this case, the operations S550 and S570 may constitute an AI/ML model update process (S500). In addition, the AI/ML model update process (S500) may be performed using the process of Method 2 of the identification process (S400), or may be performed based on the process of Method 2 but may be performed with appropriate modifications to meet the intention of the update.

The above [Embodiment 06 of Proposed Method] may be applied along with other embodiment(s) of the proposed method of the present disclosure within the range such that the other embodiment(s) does (do) not conflict with Embodiment 06 of Proposed Method.

### Embodiment 07 of Proposed Method

According to the present disclosure, in a mobile communication system including a base station and one or more UEs, when the base station and/or the UEs may support one or more AI/ML functionalities for mobile communication, a method is provided in which the base station may transmit functionality ID information for identifying AI/ML functionality-related network configurations to the UEs, the UEs may forward/transmit one or more model ID information for identifying supported models (for each AI/ML functionality-related network configuration) to the base, and the base station (or network) may operate/perform part or all of an LCM process on specific AI/ML functionalities/models using the functionality ID and the model ID.

Here, the LCM refers to LCM of the AI/ML functionalities/models, and may include data collection, model training, model inference operation, model deployment, model activation, model deactivation, model selection, model monitoring, model transfer, and the like.

Here, when reporting one or more model ID(s) to the base station, the UE may also report the functionality ID information corresponding to the model ID information.

Here, when transmitting the AI/ML functionality-related network configurations to the UE, the base station may transmit the AI/ML functionality-related network configuration, including the functionality ID information for identifying the corresponding configuration.

As an embodiment of the present disclosure, in the next-generation mobile communication system, when the base station and/or UE may support one or more AI/ML functionalities/models for mobile communication, the AI/ML functionality-related network supported configurations between the base station and the UE may first be identified and then the AI/ML supported models for each AI/ML functionality-related network configuration may be identified. Upon successfully completing the AI/ML functionalities and the AI/ML model identification process, the base station may obtain the AI/ML functionality ID and the AI/ML model ID. The base station may use a combination of the functionality ID and model ID as the identifiers for the specific AI/ML functionalities and the specific models within the AI/ML functionalities. Therefore, the base station may consider a method of performing part or all of the LCM process for the specific AI/ML functionalities/models based on the combination of the functionality ID and the model ID.

Accordingly, according to the present disclosure, in a mobile communication system including a base station and one or more UEs, when the base station and/or the UEs may support one or more AI/ML functionalities for mobile communication, a method is provided in which the base station may transmit functionality ID information for identifying AI/ML functionality-related network configurations to the UEs, the UEs may forward/transmit one or more model ID information for identifying supported models (for each AI/ML functionality-related network configuration) to the base, and the base station (or network) may perform/operate part or all of an LCM process on specific AI/ML functionalities/models using the functionality ID and the model ID.

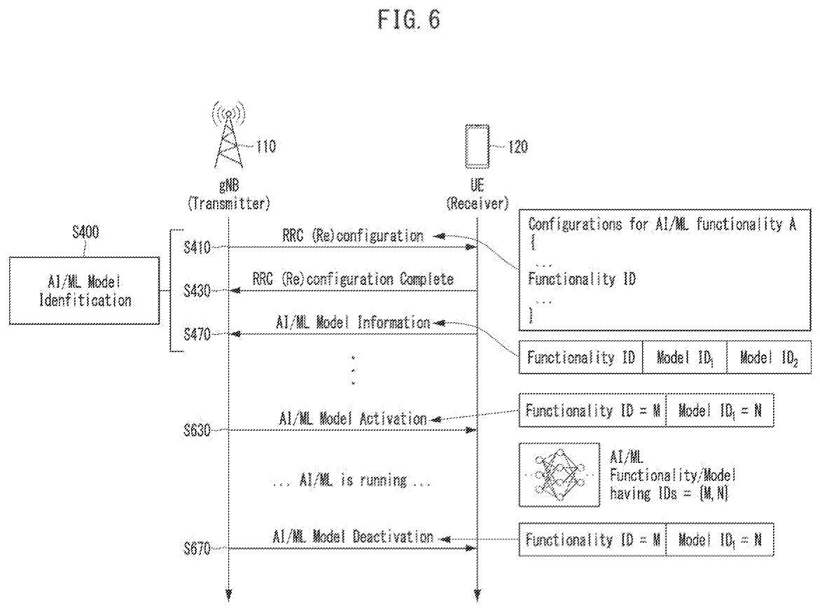

FIG. 6 exemplarily illustrates the operation according to [Embodiment 07 of Proposed Method]. FIG. 6 is a conceptual diagram illustrating a functionality/model activation/deactivation process based on the functionality ID and the model ID according to the embodiment of the present disclosure.

Referring to FIG. 6, the base station and the UE first identify the AI/ML functionalities and the supported configurations for each AI/ML functionality through the UE capability enquiry and UE capability information report process. Thereafter, the base station 110 transmits the AI/ML functionality-related network configurations through the RRC signaling within the supported configurations by the UE 120, and in this case, also transmits the AI/ML functionality ID information for identifying the AI/ML functionality-related network configurations together. Thereafter, the UE may report the AI/ML functionality identifier and/or one or more model ID information supported for the corresponding functionality ID to the base station through the MAC CE. Thereafter, the base station may forward/transmit a model activation/deactivation signal using downlink control information (DCI), MAC CE, etc., (S630 and S670), while the base station may forward/transmit the model activation/deactivation signal, including the functionality ID and model ID for the AI/ML (S630 and S670). The UE may first identify the AI/ML functionalities using the functionality ID, identify the model within the AI/ML functionalities using the model ID, and then activate the AI/ML functionalities/models. Here, the model activation/deactivation signal may have a common format. Here, the common format may include a field indicating activation/deactivation of specific models. Here, a length of the field may be 1 bit.

The above [Embodiment 07 of Proposed Method] may be applied along with other embodiment(s) of the proposed method of the present disclosure within the range such that the other embodiment(s) does (do) not conflict with Embodiment 07 of Proposed Method.

### Embodiment 08 of Proposed Method

According to the present disclosure, in a mobile communication system including a base station and one or more UEs, when the base station and/or the UEs may support one or more AI/ML functionalities for mobile communication, a method of instructing the AI/ML functionalities/models to be activated/deactivated by one or more of the following methods when the base station instructs the UEs to activate/deactivate specific AI/ML functionalities/models is provided.

### (1) Method 1: One-Way Activation/Deactivation

A. The base station instructs the activation/deactivation, and the UE follows the indication of the base station.

### (2) Method 2: Two-Way Activation/Deactivation

A. The base station instructs the activation/deactivation, and the UE responds to the indication of the base station.
B. When a positive response is transmitted, the activation/deactivation request of the base station is applied; and when a negative response is transmitted, the activation/deactivation request of the base station is not applied.

Here, the UE may report, to the base station (or network), whether to support one-way or two-way activation/deactivation operations in advance.

Here, when the UE supports both the one-way activation method and the two-way activation method, the base station (or network) may be set to apply one of the two methods to the specific AI/ML functionalities.

As an embodiment of the present disclosure, in the next-generation mobile communication system, when the base station and/or UE may support one or more AI/ML functionalities/models for mobile communication, the AI/ML functionality-related network supported configurations between the base station and the UE may first be identified and then the AI/ML supported models for each AI/ML functionality-related network configuration may be identified. Upon successfully completing the AI/ML functionalities and the AI/ML model identification process, the base station may obtain the AI/ML functionality ID and the AI/ML model ID. The base station may use a combination of the functionality ID and model ID as the identifiers for the specific AI/ML functionalities and the specific models within the AI/ML functionalities. Therefore, the base station may consider a method of performing part or all of the LCM process for the specific AI/ML functionalities/models based on the combination of the functionality ID and the model ID. Specifically, part of the LCM process may mean the activation/deactivation of the AI/ML functionalities/models.

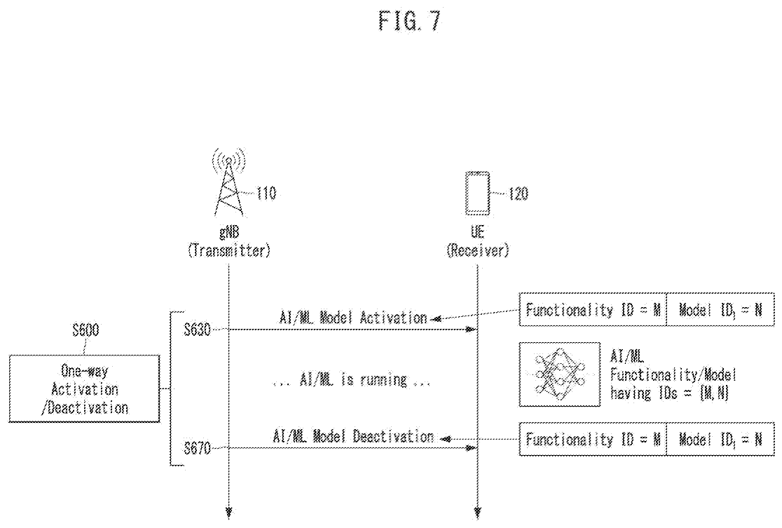

FIG. 7 is a conceptual diagram illustrating a one-way AI/ML functionality/model activation/deactivation process according to an embodiment of the present disclosure.

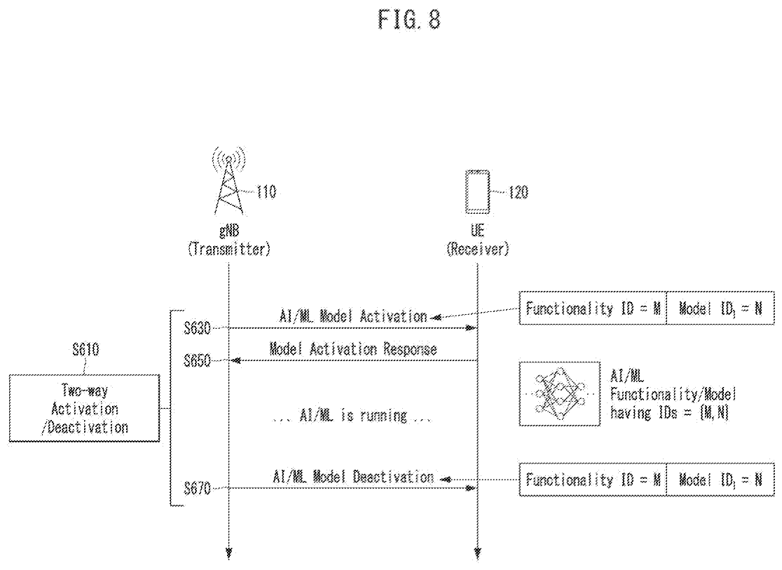

FIG. 8 is a conceptual diagram illustrating a two-way AI/ML functionality/model activation/deactivation process according to an embodiment of the present disclosure.

In general, the activation/deactivation process may be a one-way method in which the base station directs and the UE follows (see FIGS. 7, S600, S630, and S670). However, there may be cases where the model identification process between the base station and the UE was performed a long time ago, and the previously reported model identification information is different from the model information currently managed by the UE. Therefore, in addition to the one-way activation/deactivation method of the AI/ML functionalities/models (see FIG. 7, S600), the two-way activation/deactivation method in which the base station instructs and the UE responds (see FIG. 8, S610) may be considered. Specifically, the base station may request the activation/deactivation (S630 and S670), and the UE may respond to the instruction of the base station (S650). When the UE transmits the positive response, the activation/deactivation request of the base station may be applied; and when the UE transmits the negative response, the activation/deactivation request of the base station may not be applied.

Here, in the case of B of Method 2 of Proposed Method Embodiment 08, the response signal transmitted by the UE in response to the activation/deactivation request of the base station may include a 1-bit long response field. Alternatively, the transmission of the response signal by the UE may mean that the UE applies the activation/deactivation request of the UE. Conversely, the transmission of the response signal by the UE may mean that the UE does not apply the activation/deactivation request of the base station.

The above [Embodiment 08 of Proposed Method] may be applied along with other embodiment(s) of the proposed method of the present disclosure within the range such that the other embodiment(s) does (do) not conflict with Embodiment 08 of Proposed Method.

### Embodiment 09 of Proposed Method

According to the present disclosure, in a mobile communication system including a base station and one or more UEs, when the base station and/or the UEs may support one or more AI/ML functionalities/models for mobile communication, a method is provided in which the base station sets one or more timer for activating/deactivating the AI/ML functionalities/models of the UEs and controls the AI/ML functionality/model activation/deactivation state according to a timer value(s).

For example, the activation/deactivation state of the AI/ML functionalities/models may be controlled as follows according to the timer value.
(1) When one or more timer values have not expired,
A. AI/ML functionality/model activation state.
(2) When all timer values have expired,
A. AI/ML functionality/model deactivation state.

Characteristically, the AI/ML functionality/model activation may be linked to a conventional timer. For example, when the DRX state of the UE is active time, the AI/ML functionalities/models may be activated, and when the Al/ML functionalities/models are non-active time, the AI/ML functionalities/models may not be activated.

As an embodiment of the present disclosure, in the next-generation mobile communication system, when the base station and/or UE may support one or more AI/ML functionalities/models for mobile communication, the AI/ML functionality-related network supported configurations between the base station and the UEs may first be identified and then the AI/ML supported models for each AI/ML functionality-related network configuration may be identified. Upon successfully completing the AI/ML functionalities and the AI/ML model identification process, the base station may obtain the AI/ML functionality ID and the AI/ML model ID. The base station may use a combination of the functionality ID and model ID as the identifiers for the specific AI/ML functionalities and the specific models within the AI/ML functionalities. Therefore, the base station may consider a method of performing part or all of the LCM process for the specific AI/ML functionalities/models based on the combination of the functionality ID and the model ID. Specifically, part of the LCM process may mean the activation/deactivation of the AI/ML functionalities/models.

Considering that the purpose of utilizing the AI/ML functionalities/models is to achieve better performance based on data, it may be an undesirable operation for the base station to always maintain the activated state just because the base station activates the AI/ML functionalities/models of the UE. For example, an embodiment is disclosed assuming that the base station activates the AI/ML functionalities/models for the CSI report to the UE, but there is no traffic to transmit. In this case, the UE has little benefit from using the AI/ML functionalities/models, while battery consumption may be very severe. According to the present disclosure, in a mobile communication system including a base station and one or more UEs, when the base station and/or the UEs may support one or more AI/ML functionalities/models for mobile communication, a method is provided in which the base station sets one or more timer for activating/deactivating the AI/ML functionalities/models of the UEs and controls the AI/ML functionality/model activation/deactivation state according to a timer value(s).

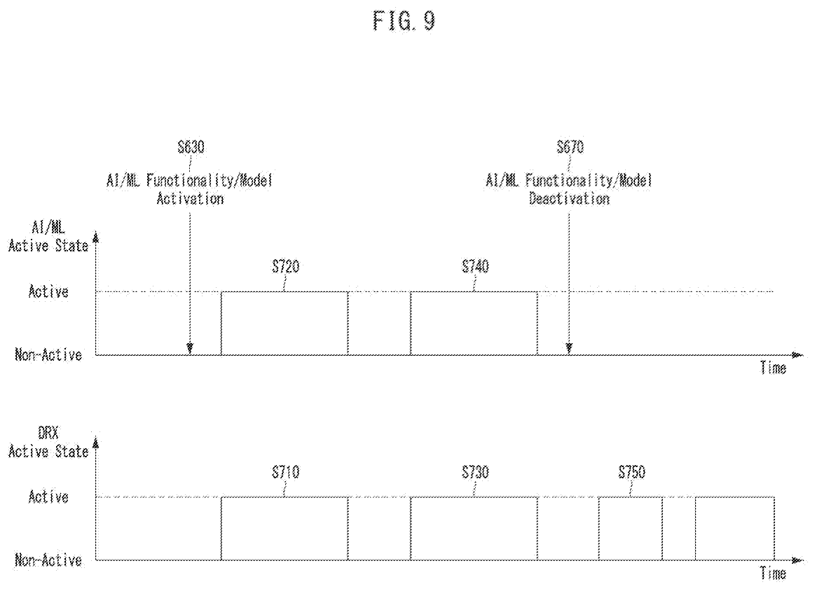

FIG. 9 exemplarily illustrates the operation according to [Embodiment 09 of Proposed Method]. FIG. 9 is a conceptual diagram illustrating a timer-based AI/ML functionality/model activation/deactivation process according to an embodiment of the present disclosure.

Referring to FIG. 9, the base station and the UE may first identify the AI/ML functionalities and the supported configurations for each AI/ML functionality through the UE capability enquiry and UE capability information report process. Thereafter, the base station 110 may forward/transmit the AI/ML functionality-related network configurations through the RRC signaling within the supported configurations by the UE 120, and in this case, also may forward/transmit the AI/ML functionality ID information for identifying the AI/ML functionality-related network configurations together. Thereafter, the UE may report the AI/ML functionality identifier and/or one or more model ID information supported for the corresponding functionality ID to the base station through the UCI, the MAC CE, etc. Thereafter, the base station may transmit a model activation/deactivation signal to the MAC CE, etc., while the base station may forward/transmit the model activation/deactivation signal to the MAC CE, including the functionality ID and/or model ID supported for the AI/ML in the MAC CE (S630 and S670). The UE may first identify the AI/ML functionalities using the functionality ID, identify the model within the AI/ML functionalities using the model ID, and then activate the AI/ML functionalities/models (S630). In this case, the UE may link the DRX state and the AI/ML functionality/model activation. That is, when the DRX state of the UE is active time (S710 and S730), the AI/ML functionalities/models may be activated (S720 and S740), and when the Al/ML functionalities/models is non-active time, the AI/ML functionalities/models may not be activated.

That is, when the base station transmits an AI/ML activation signal to the UE (S630), the UE may activate the AI/ML functionality/model based on the DRX state during a time period when the DRX state is active time (S720 and S740). Thereafter, when the base station transmits the AI/ML deactivation signal to the UE (S670), the UE does not activate the AI/ML functionality/model regardless of whether the DRX state is active time (even when it is active time (S750)).

The above [Embodiment 09 of Proposed Method] may be applied along with other embodiment(s) of the proposed method of the present disclosure within the range that the other embodiment(s) does (do) not conflict with Embodiment 09 of Proposed Method.

According to the present disclosure, for convenience of description, the types of AI/ML models are divided as follows depending on the location of the network node where the AI/ML inference operation is performed.

### One-Sided AI/ML Model

AI/ML models where the inference is performed entirely on the UE or network
When the inference is performed entirely on the UE, it is classified into a UE-sided AI/ML model, and when the inference is performed on the network, it is classified into a network-sided AI/ML model).

### Two-Sided AI/ML Model

Paired AI/ML model(s) on which common inference is performed.
Joint inference includes the AI/ML inference in which the inference is performed jointly across the UE and network.
For example, when a first part of the inference is performed by the UE and the remaining part is performed by the base station, or vice versa.

### Embodiment 10 of Proposed Method

According to the present disclosure, in a mobile communication system including a base station and one or more UEs, when the base station and/or the UEs may support one or more AI/ML functionalities/models for mobile communication, a method of reporting, by the UEs, one or more of the following information to the base station (or network) as the UE capability information is provided.
(1) Whether to support the AI/ML models download (from base station/network);
(2) When supporting the downloaded AI/ML models, supported file format;
(3) When supporting the downloaded AI/ML models, supported compilation environment;
(4) When supporting the downloaded AI/ML models, supported latency; and
(5) When supporting the downloaded AI/ML models, supported input/output (Input/Output).

Here, the report procedure of Embodiment 10 of Proposed Method may be included in the existing UE capability information report procedure. That is, the report target information of Embodiment 10 of Proposed Method may be included in the existing UE capability information. Alternatively, it may be included in the UE capability information report procedure related to the AI/ML, such as embodiments of the proposed method proposed in this specification. For example, the report procedure of Proposed Scheme Embodiment 10 may be included in the first operation S300 of Embodiment 01 of Proposed Method.

As an embodiment of the present disclosure, in the next-generation mobile communication system, when the base station and/or UE may support one or more AI/ML functionalities/models for mobile communication, the AI/ML functionalities between the base station and the UE may first be identified and then the AI/ML supported models for each AI/ML functionalities may be identified. When the base station may transmit the AI/ML models to be operated on the UE, before transmitting the AI/ML model, the base station may determine whether the UE supports the AI/ML model download and, if so, should be able to know in advance the type of AI/ML models. Specifically, the base station may transmit the AI/ML models to the UE in the form of an executable file, and the UE may report the UE capability regarding the feasibility of the AI/ML models. As information for determining the feasibility of the AI/ML model, the UE may report the information such as the supported file format, the supported compilation environment, the supported latency, and the supported input/output to the base station as the UE capability information.

The above [Embodiment 10 of Proposed Method] may be applied along with other embodiment(s) of the proposed method of the present disclosure within the range such that the other embodiment(s) does (do) not conflict with Embodiment 10 of Proposed Method.

### Embodiment 11 of Proposed Method

According to the present disclosure, in a mobile communication system including a base station and one or more UEs, when the base station and/or the UEs may support one or more AI/ML functionalities/models for mobile communication, a method of transmitting the AI/ML model configured in the base station (or network) by one or more of the following methods is provided.
(1) When transmitting the AI/ML functionality-related network configurations to the UE, the base station (or network) transmits, to the UE, the AI/ML functionality-related network configuration, including the AI/ML models configured in the base station (or network).
(2) When transmitting the AI/ML functionality-related network configurations to the UE, the base station (or network) transmits the AI/ML functionality-related network configuration, including the functionality ID, and then, transmits, to the UE, the AI/ML functionality-related network configuration, including the AI/ML models configured in the base station (or network) along with the functionality ID.

Here, when transmitting the AI/ML models to the UE, the base station (or network) may transmit the AI/ML models to the UE in the executable form or in the open format. In addition, when transmitting the models, the model ID information for identifying the corresponding models may be transmitted together.

As an embodiment of the present disclosure, in the next-generation mobile communication system, when the base station and/or UE may support one or more AI/ML functionalities/models for mobile communication, the AI/ML functionalities between the base station and the UE may first be identified and then the AI/ML supported models for each AI/ML functionalities may be identified. The base station may first identify the AI/ML functionalities that the UE can support, and then transmit and apply the network configuration to use the corresponding functionalities to the UE. In this case, in the case where operating the AI/ML models configured/trained in the base station (or network) for the network configuration, when transmitting the AI/ML functionality-related network configuration, the base station may transmit the AI/ML functionality-related network configuration, including the AI/ML models configured in the base station (or network). Here, when transmitting the AI/ML models to the UE, the base station (or network) may transmit the AI/ML models to the UE in the executable form or in the open format. As another method, when transmitting the AI/ML functionality-related network configurations to the UE, the base station may transmit the AI/ML functionality-related network configuration, including the functionality ID, and then, transmit the AI/ML functionality-related network configuration, including the AI/ML models configured in the base station (or network) along with the functionality ID. The UE may determine which functionality the corresponding model corresponds to through the Functionality ID.

The above [Embodiment 11 of Proposed Method] may be applied along with other embodiment(s) of the proposed method of the present disclosure within the range such that the other embodiment(s) does (do) not conflict with Embodiment 11 of Proposed Method.

### Embodiment 12 of Proposed Method

According to the present disclosure, in a mobile communication system including a base station and one or more UEs, when the base station and/or the UEs may support one or more AI/ML functionalities/models for mobile communication, in a process of identifying supported models for each AI/ML functionality-related network configuration, a method is provided in which the base station transmits, to the UEs, the AI/ML functionality-related network configurations, including base station-end AI/ML model information or AI/ML model identifiers paired with UE end AI/ML models, and the UEs report supportable UE end AI/ML model information or AI/ML model identifier information by referring to the base station end AI/ML model information or AI/ML model identifiers.

As an embodiment of the present disclosure, in the next-generation mobile communication system, when the base station and/or UE may support one or more AI/ML functionalities/models for mobile communication, the AI/ML functionalities between the base station and the UE may first be identified and then the AI/ML supported models for each AI/ML functionalities may be identified. Here, in addition to the single-sided AI/ML models that perform the inference only on one side of the UEs or base station, a double-sided AI/ML models that performs the inference jointly in the UEs and base station may be supported. For example, when supporting use cases such as CSI compression, the AI/ML models for the CSI compression may be divided into a UE end part and a base station end part and separately exist at both ends. Specifically, the UE end AI/ML part (or UE AI/ML model) may act as an encoder and may be responsible for compressing the channel into the CSI, and the base station end AI/ML part (or base station end AI/ML model) may act as a decoder and may be responsible for recovering the channel to the CSI. When the AI/ML models are composed of pairs as above, information exchange to identify the pairs should be supported. Therefore, in the process of identifying the supported models for each the AI/ML functionality-related network configuration, a method is provided in which the base station transmits, to the UE, the AI/ML functionality-related network configuration, including the base station end AI/ML model information or the AI/ML model identifier paired with the UE end AI/ML model when transmitting the AI/ML functionality-related network configuration, and the UE reports the supportable UE AI/ML model information or AI/ML model identifier information by referring to the base station end AI/ML model information or AI/ML models identifier. Alternatively, the base station may transmit pairing information or a pairing identifier (pairing ID) to the UE to divide a specific AI/ML model pair instead of the base station end model information or AI/ML model identifier.

The above [Embodiment 12 of Proposed Method] may be applied along with other embodiments(s) of the proposed method of the present disclosure within the range such that the other embodiment(s) does (do) not conflict with Embodiment 12 of Proposed Method.

### Embodiment 13 of Proposed Method

According to the present disclosure, in a mobile communication system including a base station and one or more UEs, when the base station and/or the UEs may support one or more AI/ML functionalities/models for mobile communication, a method of reporting the AI/ML functionalities and network configuration information supported for each AI/ML functionality, including network configuration information for collecting/reporting AI/ML functionality-related data when the UEs report the AI/ML functionalities and network configuration information supported for each AI/ML functionality in the form of the UE capability information is provided.

Here, the base station may transmit and apply the network configurations for collecting/reporting the AI/ML functionality-related data to the UE based on the UE capability information.

Here, the transmission and reception of the network configuration information may be included in the existing UE capability information report procedure. Alternatively, the transmission and reception of the network configuration information may be included in the UE capability information report procedure that is distinguished from the existing UE capability information report procedure. For example, after the existing UE capability information report operation in response to the UE capability enquiry request from the base station (or network), the AI/ML functionality-related UE capability information report procedure may be performed as an additional report operation for the network configuration information.

As an embodiment of the present disclosure, in the next-generation mobile communication system, when the base station and/or UE may support one or more AI/ML functionalities/models for mobile communication, the AI/ML functionalities between the base station and the UE may first be identified and then the AI/ML supported models for each AI/ML functionalities may be identified. For example, the base station and the UE first identify the AI/ML functionalities and the supported configurations for each AI/ML functionality through the UE capability enquiry and UE capability information report process. Thereafter, the base station may transmit the AI/ML functionality-related network configurations through the RRC signaling, etc., within the configuration that the UE can support. Thereafter, the UE may report the supported model information for the AI/ML functionality-related network configurations. However, due to the differences in the operation scenarios/environments, etc., there may be cases where there is no model that may support the AI/ML functionality-related network configuration functionalities in the area where the UE is currently connected. For example, there may be a case where there is no trained AI/ML model because not enough data has been collected for the area. However, even in the above cases, the AI/ML functionality-related network configurations may still be meaningful. The AI/ML functionality-related network configurations may include configuration for collecting/reporting the AI/ML functionality-related data in addition to the configurations for using the AI/ML functionalities. Therefore, even though the UE does not have the supported model, it may still receive the AI/ML functionality-related network configurations for the purpose of collecting/reporting data. When the AI/ML models are constructed after the data collection/report, the UE may support the AI/ML models in the corresponding area.

The above [Embodiment 13 of Proposed Method] may be applied along with other embodiment(s) of the proposed method of the present disclosure within the range such that the other embodiment(s) does (do) not conflict with Embodiment 13 of Proposed Method.

### Embodiment 14 of Proposed Method

According to the present disclosure, in a mobile communication system including a base station and one or more UEs, when the base station and/or UEs may support one or more AI/ML functionalities/models for mobile communication, a method of reporting network configurations essential to support the AI/ML functionalities/models as UE capability information and reporting auxiliarily necessary network configurations as UE assistance information is provided.

Here, the network configurations essential to support the AI/ML functionalities/models may be included in the existing UE capability information. Alternatively, the network configurations essential to support the AI/ML functionalities/models may be included in the AI/ML-related UE capability information rather than the existing UE capability information. In addition, the UE assistance information may be transmitted through signals defined for the auxiliarily necessary network configurations or may be transmitted through the existing signals.

As an embodiment of the present disclosure, in the next-generation mobile communication system, when the base station and/or UE may support one or more AI/ML functionalities/models for mobile communication, the AI/ML functionalities between the base station and the UEs may first be identified and then the AI/ML supported models for each AI/ML functionalities may be identified. For example, the base station and the UE first identify the AI/ML functionalities and the supported configurations for each AI/ML functionality through the UE capability enquiry and UE capability information report process. Thereafter, the base station may transmit the AI/ML functionality-related network configurations through the RRC signaling, etc., within the configuration that the UE can support. The network configurations may refer to essential network configurations for the AI/ML functionalities. For example, in the case of CSI prediction, configuration information on CSI-RS is essential, and the UE may report information on supportable CSI-RS configuration as the UE capability information. Meanwhile, in the CSI prediction process, the UE may use reference signal received power (RSRP) information as an auxiliary input to the AI/ML models, in addition to the CSI-RS. In this case, the RSRP-related configurations are auxiliary information, and thus, may not be transmitted as the UE capability information but may be reported to the base station or network in the form of the UE assistance information.

The above [Embodiment 14 of Proposed Method] may be applied along with other embodiment(s) of the proposed method of the present disclosure within the range that it does not conflict with Embodiment 14 of Proposed Method.

### Embodiment 15 of Proposed Method

According to the present disclosure, in a mobile communication system including a base station and one or more UEs, when the base station and/or the UEs may support one or more AI/ML functionalities/models for mobile communication, a method is provided in which the base station transmits, to the UEs, AI/ML functionality-related network configurations including base station end AI/ML model information or AI/ML model identifiers paired with UE end AI/ML models when transmitting the AI/ML functionality-related network configurations, and the UEs request the base station to transmit a data set for compatibility between the UE end AI/ML models and the base station end AI/ML models.

Here, when requesting the data set, the UE may transmit the AI/ML functionality ID and/or the base station end AI/ML model ID to the base station.

Here, when downloading the AI/ML functionality-related network configurations to the UE, the base station may be configured including whether to allow the data set transmission request of the UE.

As an embodiment of the present disclosure, in the next-generation mobile communication system, when the base station and/or UE may support one or more AI/ML functionalities/models for mobile communication, the AI/ML functionalities between the base station and the UEs may first be identified and then the AI/ML supported models for each AI/ML functionalities may be identified. Here, in addition to the single-sided AI/ML models that perform the inference only on one side of the UEs or base station, a double-sided AI/ML models that performs the inference jointly in the UEs and base station may be supported. For example, when supporting use cases such as CSI compression, the AI/ML models for the CSI compression may be divided into a UE end part and a base station end part and separately exist at both ends. Specifically, the UE end AI/ML part (or UE AI/ML model) may act as an encoder and may be responsible for compressing the channel into the CSI, and the base station end AI/ML part (or base station end AI/ML model) may act as a decoder and may be responsible for restoring the channel to the CSI. When the AI/ML models are composed of a pair as described above, the UE end AI/ML models and the base station end AI/ML models need to be compatible with each other, and a learning process or alignment process may be necessary for the compatibility. This compatibility support process may be handled outside of the standard, but when the compatibility support process is handled in a way outside of the standard, there is a risk that development schedules and development manpower among suppliers will be greatly wasted. Therefore, in the standard, it may be preferable to support the minimum number of apparatuses to perform the operation of verifying the compatibility between the UE end AI/ML model and the base station end AI/ML model. Accordingly, according to the present disclosure, when the base station and/or the UEs may support one or more AI/ML functionalities/models for mobile communication, a method is provided in which the base station transmits, to the UEs, AI/ML functionality-related network configurations including base station end AI/ML model information or AI/ML model identifiers paired with UE end AI/ML models when transmitting the AI/ML functionality-related network configurations, and the UEs request to transmit a data set for compatibility between the UE end AI/ML models and the base station end AI/ML models. The UE may re-train the UE end AI/ML models based on the data set or partially modify the UE end AI/ML models to update the UE end AI/ML models to be compatible with the base station end AI/ML models. As a modification of the embodiment of the proposed method, when the base station and/or the UE may support one or more AI/ML functionalities/models for mobile communication, the base station may request the UE to transmit the data set for the compatibility of the UE end AI/ML models and the base station end AI/ML models. In this case, the request may include the AI/ML functionality ID and/or the UE end AI/ML models ID.

The above [Embodiment 15 of Proposed Method] may be applied along with other embodiment(s) of the proposed method of the present disclosure within the range such that the other embodiment(s) does (do) not conflict with Embodiment 15 of Proposed Method.

### Embodiment 16 of Proposed Method

According to the present disclosure, in a mobile communication system including a base station and one or more UEs, when the base station and/or the UEs may support one or more AI/ML functionalities for mobile communication, a method is provided in which application conditions for the AI/ML functionalities are classified into first application conditions that do not depend on a scenario/area/dataset and second application conditions that depend on the scenario/area/dataset, the first application conditions supportable by the UEs are identified and then the AI/ML functionalities are configured based on the first application conditions, and the second application conditions supportable by the UEs are identified for each configured AI/ML functionality.

For example, the first application conditions and the second application conditions supportable by the UE may be identified as in the following procedure.

### (1) First Operation

A. The UE reports the supportable first application conditions to the base station through the UE capability report process.

### (2) Second Operation

A. The base station configures the AI/ML functionalities in the UE based on the first application conditions supportable by the UE.

### (3) Third Operation

A. The base station transmits candidate groups of the second application conditions for each AI/ML functionality to the UE.

### (4) Fourth Operation

A. The UE reports to the base station whether it supports each second application condition transmitted by the base station.

Here, the second operation and the third operation may be performed at the same time point (or slot) or at different time points (or slots).

Here, the base station may activate only the AI/ML functionalities that satisfy both the first application conditions and the second application conditions.

As an embodiment of the present disclosure, in the next-generation mobile communication system, an embodiment is disclosed assuming that the base station and/or the UE may support one or more AI/ML functionalities for mobile communication. The application conditions for the AI/ML functionalities may be classified into the application conditions (hereinafter, first application conditions) that do not depend on the scenario/region/dataset and the application conditions (second application conditions) that depend on the scenario/region/dataset. Among these, the second application conditions are newly required application conditions because the AI/ML functionalities are functionalities based on data and training, and compared to the first application conditions, the number of cases for the second application conditions may be relatively large. For example, the second application conditions for the AI/ML functionalities may correspond to one of the areas divided for collecting the dataset. In the above case, the second application conditions may exist as many as the number of datasets divided from each other. Considering the above characteristics, rather than reporting the first application condition and the second application conditions for all the AI/ML functionalities supportable by the UE, it may be a more efficient procedure to first check the first application conditions to configure the AI/ML functionalities based on the first application conditions and then check the second application conditions supportable for each AI/ML functionality configured above. For example, the first application conditions may be reported by the UE to the base station through the UE capability report process, and the base station may configure the AI/ML functionalities in the UE based on the first application conditions. In this case, the AI/ML functionality configuration may mean that the AI/ML functionalities is not always effective within a mobility management range related to the UE capability report, but there is a local area in which the corresponding AI/ML functionalities are valid. Thereafter, the base station transmits the candidate groups of the second application conditions for each AI/ML functionality to the UE, and the UE may report, to the base station, whether it supports each second application condition transmitted by the base station.

Alternatively, as a modification of [Embodiment 16 of Proposed Method] above, a method of identifying the first application conditions and the second application conditions supportable by the UE may be considered as in the following procedure. In the method below, when the base station transmits the candidate groups of the second application conditions to the UE, there is an advantage of minimizing overlapping signaling between the functionalities by transmitting the candidate groups of the second application conditions common to the AI/ML functionalities and/or for each AI/ML functionality.

### (1) First Operation

A. The UE reports the supportable first application conditions to the base station through the UE capability report process.

### (2) Second Operation

A. The base station configures the AI/ML functionalities in the UE based on the first application conditions supportable by the UE.

### (3) Third Operation

A. The base station transmits the candidate groups of the second application conditions common to the AI/ML functionalities and/or for each AI/ML functionality to the UE.

### (4) Fourth Operation

A. The UE reports to the base station whether it supports each second application condition transmitted by the base station.

The above [Embodiment 16 of Proposed Method] may be applied along with other embodiment(s) of the proposed method of the present disclosure within the range such that the other embodiment(s) does (do) not conflict with Embodiment 16 of Proposed Method.

### Embodiment 17 of Proposed Method

According to the present disclosure, in a mobile communication system including a base station and one or more UEs, when the base station and/or the UEs may support one or more AI/ML functionalities for mobile communication, a method is provided in which application conditions for the AI/ML functionalities are classified into first application conditions that do not depend on a scenario/area/dataset and second application conditions that depend on the scenario/area/dataset, candidate groups of the second application conditions are defined and configured to be common to the AI/ML functionalities, and the first application conditions and the second application conditions supportable by the UEs are identified based thereon.

For example, the first application conditions and the second application conditions supportable by the UE may be identified as in the following procedure.

### (1) First Operation

A. The base station requests the UE capability report from the UE through the UE capability enquiry process.
B. The base station transmits the candidate groups of the second application conditions common to the AI/ML functionalities within the UE capability enquiry process.

### (2) Second Operation

A. The UE reports the supportable first application conditions and second application conditions to the base station through the UE capability report process.

Here, the base station may activate only the AI/ML functionalities that satisfy both the first application conditions and the second application conditions.

Here, the UE may report the first application condition(s) and/or the second application condition(s) for each functionality in the second operation.

As an embodiment of the present disclosure, in the next-generation mobile communication system, an embodiment is disclosed assuming that the base station and/or the UE may support one or more AI/ML functionalities for mobile communication. The application conditions for the AI/ML functionalities may be classified into the application conditions (hereinafter, first application conditions) that do not depend on the scenario/region/dataset and the application conditions (second application conditions) that depend on the scenario/region/dataset. Among these, the second application conditions are newly required application conditions because the AI/ML functionalities are functionalities based on data and training, and compared to the first application conditions, the number of cases for the second application conditions may be relatively large. For example, the second application conditions for the AI/ML functionalities may correspond to one of the areas divided for collecting the dataset. In the above case, the second application conditions may exist as many as the number of datasets divided from each other. Considering the above characteristics, when the second application conditions are to be identified for each functionality, the number of cases to be identified may be present as many as the product of the number of functionalities and the number of datasets. As a more efficient method, the present disclosure provides a method of commonly defining and configuring the candidate groups of the second application conditions as the AI/ML functionalities and identifying the first application conditions and the second application conditions supportable by the UE based thereon. For example, in the UE capability enquiry process, the base station may request the UE capability report from the UE and transmit the candidate groups of the second application conditions common to the AI/ML functionalities. Thereafter, the UE may report, to the base station, the first and second application conditions supportable based on the candidate group in the UE capability report process.

The above [Embodiment 17 of Proposed Method] may be applied along with other embodiment(s) of the proposed method of the present disclosure within the range such that the other embodiment(s) does (do) not conflict with Embodiment 17 of Proposed Method.

### Embodiment 18 of Proposed Method

According to the present disclosure, in a mobile communication system including a base station and one or more UEs, when the base station and/or the UEs may support one or more AI/ML functionalities for mobile communication, a method is provided in which application conditions for the AI/ML functionalities are classified into first application conditions that do not depend on a scenario/area/dataset and second application conditions that depend on the scenario/area/dataset, area information where UE capability information is managed is transmitted to the UEs, and the first application conditions and the second application conditions supportable by the UEs within the area are identified.

For example, the first application conditions and the second application conditions supportable by the UE may be identified as in the following procedure.

### (1) First Operation

A. The base station requests the UE capability report from the UE through the UE capability enquiry request.
B. When requesting the UE capability enquiry, the base station transmits information on the area where the UE capability report is managed to the UE.
   i. Here, the area information may include cell identifier information.

### (2) Second Operation

A. The UE reports, to the base station, the supportable first application conditions and second application conditions within the area where the UE capability report is managed.

### (3) Third Operation

A. The base station requests to enquire the second applicable conditions that the UE can support for a specific cell within the area where the UE capability report is managed.
(4) Fourth Operation
A. The UE reports the second application conditions that the UE can support for the specific cell in the area where UE capability report is managed.

Here, the base station may activate only the AI/ML functionalities that satisfy both the first application conditions and the second application conditions.

Here, the base station may omit the third operation in some cases.

Here, the UE may report the first application condition(s) and/or the second application condition(s) for each functionality in the second operation.

As an embodiment of the present disclosure, in the next-generation mobile communication system, an embodiment is disclosed assuming that the base station and/or the UE may support one or more AI/ML functionalities for mobile communication. The application conditions for the AI/ML functionalities may be classified into the application conditions (hereinafter, first application conditions) that do not depend on the scenario/region/dataset and the application conditions (second application conditions) that depend on the scenario/region/dataset. Among these, the second application conditions are newly required application conditions because the AI/ML functionalities are functionalities based on data and training, and compared to the first application conditions, the number of cases for the second application conditions may be relatively large. For example, the second application conditions for the AI/ML functionalities may correspond to one of the areas divided for collecting the dataset. In the above case, the second application conditions may exist as many as the number of datasets divided from each other. Considering the above characteristics, reporting the second application condition as the UE capability report as in the related art may not be an efficient method, and it is necessary to consider a method of gradually reducing the candidate groups of the second application conditions. Therefore, the present disclosure proposes a method of transmitting the information on the area where UE capability information is managed to the UE and identifying the first application conditions and the second application conditions supportable by the UE within the area. For example, in the UE capability enquiry process, the base station may request the UE capability report from the UE while transmitting the information on the area where the UE capability information is managed. Thereafter, the UE may report, to the base station, the first and second application conditions supportable within the area in the UE capability report process. Next, the base station and the UE may identify the final second application conditions supportable for a specific cell within the area.

The above [Embodiment 18 of Proposed Method] may be applied along with other embodiment(s) of the proposed method of the present disclosure within the range such that the other embodiment(s) does (do) not conflict with Embodiment 18 of Proposed Method.

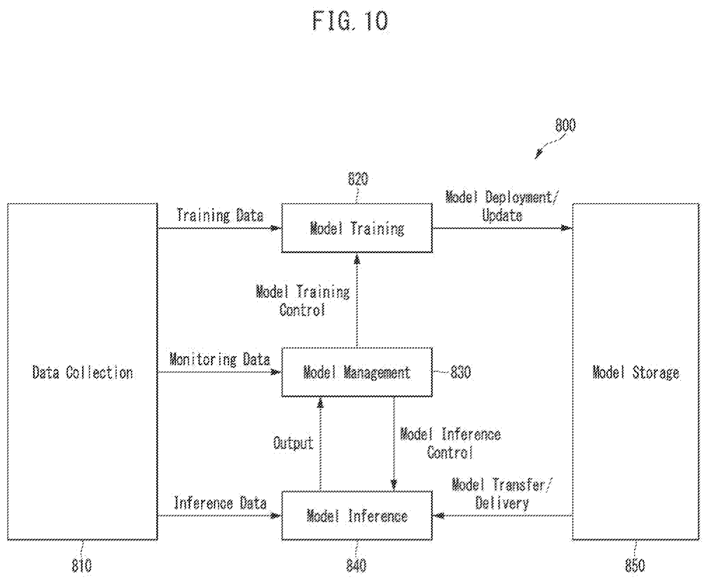

Hereinafter, an AI/ML framework will be described. FIG. 10 illustrates the AI/ML framework according to an embodiment of the present disclosure. The AI/ML functionality/model(s) referenced in the embodiment(s) of the proposed method of the present disclosure may perform each functionality based on the AI/ML framework of FIG. 10 and may be managed as individual or integrated models.

Referring to FIG. 10, an AI/ML framework 800 may include a data collection block 810, a model training block 820, a model management block 830, a model inference block 840, and a model storage block 850. FIG. 10 is only an example of the AI/ML framework, and various entities/functions/blocks not disclosed in FIG. 10 may be added to the AI/ML framework, and at least some of the blocks disclosed in FIG. 10 may be omitted.

The data collection block 810 may be performed for various purposes in the LCM, such as model training, model inference, model monitoring, model selection, and model update. The data collection block 810 of FIG. 10 may be a block that conceptually represents data sources and entities that hold data for training, inference, and monitoring. Although the data collection block 810 in FIG. 10 is represented as a single block, data collection for the training, inference, and monitoring may have various characteristics and requirements. In addition, a timescale (e.g., real-time or offline, etc.) of the training and monitoring may require individual considerations.

Regarding the training, the training data may be initially generated in the network and UE. Initial data may be collected (or transmitted) to one or more data collection entities. The data collection entity may be owned by various entities such as internal entities to the network, or external entities to the network such as UE/chipset/network vendors, network operators, and positioning service providers.

Regarding the inference, inference data for the UE-side model and/or the UE portion of the two-sided models may be transmitted or provided directly from the UE. The inference data for the network-side model and/or the network portion of the two-sided models may be transmitted or provided directly in the network or may be transmitted from the UE.

Regarding the monitoring, the monitoring data for the UE-side monitoring may be transmitted or provided directly from the UE. The monitoring data for the network-side monitoring may be transmitted or provided directly from the network, or may be transmitted from the UE.

The data collection for real-time operations such as real-time model monitoring, switching, and selection may incur significant signaling overhead. Conversely, infrequent data collection to reduce the signaling overhead may cause latency for real-time model monitoring, switching, and selection.

The model training block 820 may include both the initial training and model update. In general, the model training may be classified into the model training that is performed along with model development and follow-up training for the developed model. The model training block 820 in FIG. 10 is expressed as one block for simplicity.

Depending on the location of the dataset and/or the area where the model (or untrained model) is located, the training may be performed by the internal entities to the network or by the external entities such as the UE/chipset/network vendors, the network operators, and the positioning service providers. Since the AI/ML model development is generally an iterative process of data collection, model design, training, and performance verification, power consumption, hardware area, latency, and concurrency with other layer functions need to be carefully considered for the AI/ML model development.

When large-scale field data is collected from the data collection entity, the data should be made available to a supplier responsible for model development. Generally, the model development is an offline engineering process performed by engineering teams, and needs to be performed by accessing large data sets collected in the field. That is, a decision on a model structure, device-specific optimization, and the number of models to develop (e.g., possible generalization vs. specific models) may change depending on the large-scale field data. When the supplier that owns the data collection entity is different from the supplier responsible for developing the model, the dataset should be made available to the supplier responsible for developing the models. This may be done by sharing the explicit dataset or providing the access to the collected datasets. The sharing/access of the dataset may be associated with a two-sided model where both a gNB supplier and a UE/chipset supplier should participate in the model development and training process.

After models are developed and trained, the models may be stored in a model repository or model storage block (X50) and transmitted to a target apparatus. The models may be compiled into executable files for inference. Here, there may be various methods depending on a location where the models are trained, a model storage/transmission format, a location where the model is hosted before the models are transmitted, etc.

The model inference block 840 serves to provide the AI/ML model inference output, such as prediction or decision. The model inference block 840 may provide model performance feedback to the model training block 820. The model inference block 840 may be responsible for data preparation, such as data preprocessing, cleaning, formatting, and conversion, based on the inference data transmitted by the data collection block 810.

The model management may include functionality/model monitoring, selection, activation, deactivation, switching, fallback, etc. Although FIG. 10 illustrates one model management block 830, all aspects of model management may not be implemented in a single location. Some aspects of the model monitoring, activation/deactivation, selection, switching, and fallback may be performed on the network side, and other aspects may be performed on the UE side. Regarding the model selection, the activation, the deactivation, the switching, and the fallback for the UE-side model and two-sided model, mechanism related to decisions by the network is initiated by the network, mechanism related to a decision by the network that is initiated by the UE and requested to the network, mechanism related to the decision by the UE that is event-triggered by the network and where the decision of the UE is reported to the network, mechanism related to the decision by the UE that is UE-autonomous and where the decision of the UE is reported to the network, mechanism related to the decision by the UE that is UE-autonomous and where the decisions of the UE are not reported to the network may be considered.

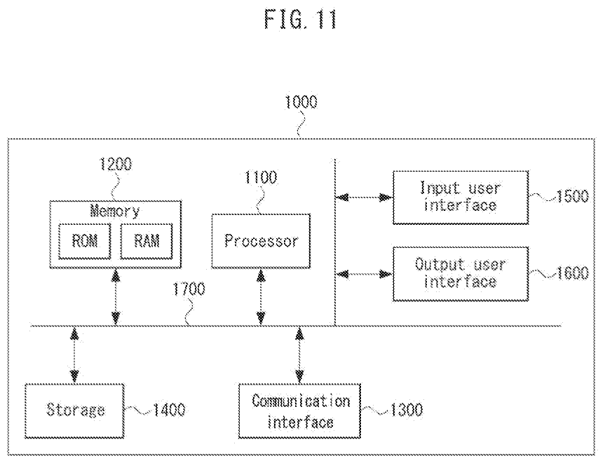

FIG. 11 is a conceptual diagram illustrating an example of a generalized computing system in which a base station and/or a UE in mobile communication system capable of performing at least part of the processes of FIGS. 1 to 10 are implemented.

At least some processes of the method of identifying and managing AI/ML functionalities and/or models supported for mobile communication according to an embodiment of the present disclosure may be executed by a computing system 1000 of FIG. 11.

Referring to FIG. 11, the computing system 1000 according to an embodiment of the present disclosure may include a processor 1100, a memory 1200, a communication interface 1300, a storage device 1400, an input interface 1500, an output interface 1600, and a bus 1700.

The computing system 1000 according to the embodiment of the present disclosure may include at least one processor 1100 and the memory 1200 storing instructions instructing the at least one processor 1100 to perform at least one operation. At least some operations of the method according to the embodiment of the present disclosure may be performed by the at least one processor 1100 that loads instructions from the memory 1200 and executes the instructions.

The processor 1100 may mean a central processing unit (CPU), a graphics processing unit (GPU), or a dedicated processor on which the methods according to the embodiments of the present disclosure are performed.

Each of the memory 1200 and the storage device 1400 may include at least one of a volatile storage medium and a non-volatile storage medium. For example, the memory 1200 may include at least one of read only memory (ROM) and random access memory (RAM).

In addition, the computing system 1000 may include the communication interface 1300 that performs communication through a wireless network.

In addition, the computing system 1000 may further include the storage device 1400, the input interface 1500, the output interface 1600, etc.

In addition, each component included in the computing system 1000 may communicate with each other by being connected by a bus 1700.

Examples of the computing system 1000 of the present disclosure include a communicable desktop computer, a laptop computer, laptop, smart phone, a tablet personal computer (PC), a mobile phone, a smart watch, a smart glass, an e-book reader, a portable multimedia player (PMP), a portable game machine, a navigation device, a digital camera, a digital multimedia broadcasting (DMB) player, a digital audio recorder, a digital audio player, s digital video recorder, a digital video player, a personal digital assistant (PDA), etc.

An entity (base station and/or UE) included in mobile communication systems according to an embodiment of the present disclosure includes the memory 1200 that stores at least one command; and the processor 1100 that performs at least one instruction. The processor 1100 may perform a method of identifying and managing AI/ML functionalities/models of the present disclosure by executing at least one command.

The operations of the method according to the exemplary embodiment of the present disclosure can be implemented as a computer readable program or code in a computer readable recording medium. The computer readable recording medium may include all kinds of recording apparatus for storing data which can be read by a computer system. Furthermore, the computer readable recording medium may store and execute programs or codes which can be distributed in computer systems connected through a network and read through computers in a distributed manner.

The computer readable recording medium may include a hardware apparatus which is specifically configured to store and execute a program command, such as a ROM, RAM or flash memory. The program command may include not only machine language codes created by a compiler, but also high-level language codes which can be executed by a computer using an interpreter.

Although some aspects of the present disclosure have been described in the context of the apparatus, the aspects may indicate the corresponding descriptions according to the method, and the blocks or apparatus may correspond to the steps of the method or the features of the steps. Similarly, the aspects described in the context of the method may be expressed as the features of the corresponding blocks or items or the corresponding apparatus. Some or all of the steps of the method may be executed by (or using) a hardware apparatus such as a microprocessor, a programmable computer or an electronic circuit. In some embodiments, one or more of the most important steps of the method may be executed by such an apparatus.

In some exemplary embodiments, a programmable logic device such as a field-programmable gate array may be used to perform some or all of functions of the methods described herein. In some exemplary embodiments, the field-programmable gate array may be operated with a microprocessor to perform one of the methods described herein. In general, the methods are preferably performed by a certain hardware device.

The description of the disclosure is merely exemplary in nature and, thus, variations that do not depart from the substance of the disclosure are intended to be within the scope of the disclosure. Such variations are not to be regarded as a departure from the spirit and scope of the disclosure. Thus, it will be understood by those of ordinary skill in the art that various changes in form and details may be made without departing from the spirit and scope as defined by the following claims.

What is claimed is:

1. A method of identifying artificial intelligence (AI)/machine learning (ML) functionalities/models supported for mobile communication operated in mobile communication systems including a base station and one or more user equipments (UEs), the method comprising:
identifying, by at least one of the base station or the one or more UEs, information related to the AI/ML functionalities supportable by the one or more UEs; and
identifying, by at least one of the base station or the one or more UEs, AI/ML model information supportable by the one or more UEs.

2. The method of claim 1, wherein, in the identifying of the information related to the AI/ML functionalities supportable by the one or more UEs, the information related to the AI/ML functionalities supportable by the one or more UEs and network configuration information supported for each AI/ML functionality supportable by the one or more UEs are identified together.

3. The method of claim 1, wherein, in the identifying of the AI/ML model information supportable by the one or more UEs, AI/ML model information supported for each AI/ML functionality-related network configuration (radio resource control (RRC) (Re)configuration) is identified.

4. The method of claim 1, wherein the identifying of the information related to the AI/ML functionalities supportable by the one or more UEs includes:
requesting, by the base station, a UE capability enquiry to the UE; and
reporting, by the UE, UE capability information to the base station in response to the UE capability enquiry.

5. The method of claim 4, wherein, in the reporting of, by the UE, the UE capability information to the base station in response to the UE capability enquiry, the UE capability information including the AI/ML functionalities and the network configuration information supported for each AI/ML functionality is forwarded to the base station.

6. The method of claim 5, wherein, in the reporting of, by the UE, the UE capability information to the base station in response to the UE capability enquiry, the UE capability information including at least one of whether the network configuration information supported for each AI/ML functionality is shared for a plurality of AI/ML functionalities or whether the network configuration information is specialized for individual AI/ML functionalities is forwarded to the base station.

7. The method of claim 4, wherein, in the reporting of, by the UE, the UE capability information to the base station in response to the UE capability enquiry, general UE capability information and AI/ML functionality-related UE capability information are reported individually or in an integrated process based on a result of decision on whether to report the general UE capability information and the AI/ML functionality-related UE capability information in respective processes or not.

8. The method of claim 1, wherein the identifying of the AI/ML model information supportable by the one or more UEs includes:
forwarding, by the base station, AI/ML-related network configuration (RRC (Re)configuration) to the UE; and
reporting, by the UE, at least one of model identifier (model ID) information or model information supportable by the UE to the base station.

9. The method of claim 8, wherein the AI/ML-related network configuration (RRC (Re)configuration) includes a functionality identifier (functionality ID).

10. The method of claim 8, wherein, in the reporting of, by the UE, the at least one of the model ID information or the model information supportable by the UE to the base station, the UE reports at least one of model ID information or model information supported for each AI/ML functionality-related network configuration, along with functionality ID information supported for each AI/ML functionality-related network configuration.

11. The method of claim 8, wherein the identifying of the AI/ML model information supportable by the one or more UE further includes, after the forwarding of, by the base station, the AI/ML-related network configuration (RRC (Re)configuration) to the UE, forwarding, to the UE, a trigger requesting the one or more model information and the model ID information supportable by the UE.

12. The method of claim 11, wherein, after the trigger is forwarded, a timer is set until the UE reports at least one of the model ID information or the model information supportable by the UE in response to the trigger, and
when the UE does not report at least one of the model ID information or the model information supportable by the UE until the timer expires, it is determined that the UE does not respond to valid model information.

13. The method of claim 1, wherein, in the identifying of the information related to the AI/ML functionalities supportable by the one or more UEs, the base station forwards at least one of operation scenario or operation zone information along with network configuration information supported for each AI/ML functionality to the UE, and
in the identifying of the AI/ML model information supportable by the one or more UEs, the UE reports the at least one of the model ID information or the model information supportable by the UE based on the at least one of the operation scenario or the operation zone information.

14. The method of claim 13, wherein the operation scenario is one of indoor or outdoor scenarios, and
at least one of the operation scenario or the operation zone information is related to AI/ML-based positioning.

15. A mobile communication system including a base station and one or more user equipments (UEs), wherein:
application conditions for artificial intelligence (AI)/machine learning (ML) functionalities to be applied in at least one of the base station or the one or more UEs are classified into a first application condition independent of a scenario, an area, and a dataset, or a second application condition depends on at least one of the scenario, the area, or the dataset;
the base station sets the AI/ML functionalities based on the first application condition which is identified by the one or more UEs and is supportable by the one or more UEs; and
the second application condition supportable by the one or more UEs for each of the set AI/ML functionalities is identified for the each of the set AI/ML functionalities.

16. The mobile communication system of claim 15, wherein the at least one of the base station or the one or more UEs identify information related to the AI/ML functionalities supportable by the one or more UEs, and identify AI/ML model information supportable by the one or more UEs,
the base station requests a UE capability enquiry to the UE,
the UE reports UE capability information to the base station in response to the UE capability enquiry,
the base station forwards AI/ML-related network configuration (RRC (Re)configuration) to the UE, and
the UE reports at least one of one or more model information or model identifier (model ID) information supportable by the UE to the base station.

17. A method of managing artificial intelligence (AI)/machine learning (ML) functionalities/models supported for mobile communication operated in mobile communication systems including a base station and one or more user equipments (UEs), the method comprising:
forwarding, by the base station, functionality identifier (functionality ID) information for identifying AI/ML functionality-related network configurations (RRC (Re)configuration) to the UE;
forwarding, by the UE, one or more model ID information for identifying supported models for each AI/ML functionality-related network configuration to the base station; and
operating, by the base station, at least part of a life cycle management (LCM) process for specific AI/ML functionalities/models using the functionality ID information and the model ID information.

18. The method of claim 17, wherein the LCM process includes at least one of data collection, model training, model inference operation, model deployment, model activation, model deactivation, model selection, model monitoring, or model transfer.

19. The method of claim 17, wherein the operating of at least part of the LCM process includes forwarding, by the base station, activation/deactivation information on at least one of specific AI/ML functionalities/models to the UE,
when the base station and the UE follow one-way activation/deactivation conditions, the base station instructs activation/deactivation of at least one of the specific AI/ML functionalities/models based on the activation/deactivation information, and
when the base station and the UE follow a two-way activation/deactivation condition, the base station requests the activation/deactivation of at least one of the specific AI/ML functionalities/models based on the activation/deactivation information, and the UE affirms or denies the activation/deactivation request.

20. The method of claim 17, wherein the operating of at least part of the LCM process includes:
forwarding, by the base station, the activation/deactivation information on at least one of the specific AI/ML functionalities/models to the UE; and
controlling at least one of the specific AI/ML functionalities/models of the UE to be activated/deactivated based on one or more timers for activating/deactivating at least one of the specific AI/ML functionalities/models configured by the base station.
